(19) United States
(12) Patent Application Publication
(10) Pub. No.: US 2021/0232899 A1
(43) Pub. Date: Jul. 29, 2021

(54) NEURAL ELECTRONIC CIRCUIT

(71) Applicant: Tokyo Institute of Technology, Tokyo (JP)

(72) Inventors: Shinya Takamaeda, Sapporo-shi (JP); Kodai Ueyoshi, Sapporo-shi (JP); Masato Motomura, Tokyo (JP)

(21) Appl. No.: 16/967,551

(22) PCT Filed: Jan. 25, 2019
(86) PCT No.: PCT/JP2019/002455

§ 371 Date: Aug. 5, 2020

(30) Foreign Application Priority Data
Feb. 6, 2018 (JP) 2018-019252

(51) Int. Cl. G06N 3/063; G06N 3/04; G06F 7/485; G06F 7/487; G06F 7/544

(52) U.S. Cl. CPC G06N 3/063; G06N 3/0481; G06F 7/5443; G06F 7/485; G06F 7/4876; G06N 3/0454

(57) ABSTRACT

The neural electronic circuit includes: a storage unit (MC) that stores a logarithmic weighting coefficient, in which a value obtained by logarithmizing a weighting coefficient corresponding to input data that is input is expressed in multiple bits, and outputs the logarithmic weighting coefficient bit by bit; a first electronic circuit unit (Pe) that outputs a multiplication result of the input data and the weighting coefficient; and a second electronic circuit unit (Act) that realizes addition and application functions for adding up the multiplication results, applying an activation function to the addition result, and outputting output data. Logarithmic input data expressed in multiple bits is received bit by bit, a logarithmic addition is calculated by adding up the logarithmic input data and the logarithmic weighting coefficient output from the storage unit, the multiplication result is calculated by linearizing the logarithmic addition result, and the output data that is logarithmized is output.

### TECHNICAL FIELD

The present invention relates to the technical field of a neural electronic circuit that realizes a neural network by an electronic circuit.

### BACKGROUND ART

In recent years, research and development have been performed on a so-called neural network circuit obtained by modeling a human brain function. At this time, a conventional neural network circuit is often realized by using a product-sum operation using a floating point or a fixed point, for example. In this case, for example, there has been a problem that the operation cost is high and the processing load is high.

Therefore, in recent years, an algorithm of a so-called “binary neural network circuit” has been proposed in which each of the input data and the weighting coefficient is one bit. Here, as a citation list showing the algorithm of the above binary neural network circuit, for example, the following Non Patent Document 1 and Non Patent Document 2 can be mentioned.

### CITATION LIST

### Non Patent Document

Non Patent Document 1: “XNOR-Net: ImageNet Classification Using Binary Convolutional Neural Networks” paper, Mohammad Rastegari et al., arXiv:1603.05279v2 [cs.CV, Apr. 19, 2016 (URL: http://arxiv.org/abs/1603.05279)
Non Patent Document 2: “Binarized Neural Networks: Training Neural Networks with Weights and Activations Constrained to +1 or −1”, Matthieu Courbariaux et al., arXiv:1602.02830v3 [cs.LG], Mar. 17, 2016 (URL: http://arxiv.org/abs/1602.02830)

### SUMMARY OF THE INVENTION

### Problem to be Solved by the Invention

However, none of the above-described Non Patent Documents describes how to specifically realize the theory described in the paper. In addition, it is desired to enable parallel operations by using the fact that the unit operation cost is significantly reduced by the theory described in each paper, but the hardware configuration for the purpose is also unknown. In order to further improve the recognition accuracy, it is necessary to handle multi-bit data.

Therefore, the present invention has been made in view of the above problems, requirements, and the like, and an example of the object is to provide a neural electronic circuit capable of realizing a neural network, which can handle multi-bit data, while reducing the electronic circuit scale by using the algorithm of the binary neural network circuit described above.

### Means for Solving the Problem

In order to solve the aforementioned problems, an invention according to claim 1 includes: a storage unit that stores a logarithmic weighting coefficient, in which a value obtained by logarithmizing a weighting coefficient corresponding to input data that is input is expressed in multiple bits, and outputs the logarithmic weighting coefficient bit by bit; a first electronic circuit unit that outputs a multiplication result of the input data and the weighting coefficient; and a second electronic circuit unit that realizes addition and application functions for adding up the multiplication results from the first electronic circuit units, applying an activation function to the addition result, and outputting output data. The first electronic circuit unit receives logarithmic input data, in which a value obtained by logarithmizing the input data is expressed in multiple bits, bit by bit, calculates a logarithmic addition by adding up the logarithmic input data and the logarithmic weighting coefficient output from the storage unit, and calculates the multiplication result by linearizing the logarithmic addition result. The second electronic circuit unit outputs the output data that is logarithmized.

According to an invention according to claim 2, in the neural electronic circuit according to claim 1, the second electronic circuit unit outputs the logarithmic output data by applying the activation function to the logarithmic addition result obtained by logarithmizing the addition result.

According to an invention according to claim 3, in the neural electronic circuit according to claim 2, the first electronic circuit unit calculates an approximate multiplication result by the linearization of the logarithmic addition result using an approximate expression, and the second electronic circuit unit outputs the output data that is logarithmized by adding up the approximate multiplication results by an approximate expression.

According to an invention according to claim 4, in the neural electronic circuit according to any one of claims 1 to 3, the storage unit stores the logarithmic weighting coefficient according to each of the pieces of parallel logarithmic input data that are input in parallel, the first electronic circuit unit is set in each of the pieces of parallel logarithmic input data, and the second electronic circuit unit adds up the multiplication results of the pieces of parallel logarithmic input data from the first electronic circuit unit.

According to an invention according to claim 5, in the neural electronic circuit according to claim 4, the storage unit and the second electronic circuit unit are set according to the pieces of output data that are output in parallel.

According to an invention according to claim 6, in the neural electronic circuit according to claim 4 or 5, a temporary storage unit that is provided for each of the first electronic circuit units to temporarily store the multiplication result from each of the first electronic circuit units is further provided, the temporary storage units are set in series and sequentially transfer the multiplication results to the second electronic circuit unit.

According to an invention according to claim 7, in the neural electronic circuit according to any one of claims 4 to 6, the storage unit sequentially outputs logarithmic weighting coefficients corresponding to the logarithmic input data, which is sequentially input to the first electronic circuit unit, to the first electronic circuit unit bit by bit.

According to an invention according to claim 8, in the neural electronic circuit according to claim 7, the first electronic circuit unit outputs a partial addition result obtained by adding up the multiplication results by the input parallel number of pieces of logarithmic input data that are input in parallel, and the second electronic circuit unit calculates the addition result from the partial addition result.

According to an invention according to claim 9, in the neural electronic circuit according to any one of claims 4 to 6, the storage unit outputs a logarithmic weighting coefficient corresponding to each of the pieces of parallel logarithmic input data, which are input in parallel, to the first electronic circuit units bit by bit.

According to an invention according to claim 10, in the neural electronic circuit according to claim 9, when the input parallel number of pieces of logarithmic input data is larger than an inputtable parallel number by which the pieces of logarithmic input data are inputtable at a time in parallel, the first electronic circuit unit receives the logarithmic input data in parallel by the inputtable parallel number and then receives the remaining logarithmic input data that could not be received in parallel by the inputtable parallel number, and the storage unit outputs the logarithmic weighting coefficient corresponding to the remaining logarithmic input data.

### Effect of the Invention

According to the present invention, since the multiplication result of the input data and the weighting coefficient is calculated by performing logarithmic addition by adding the logarithmic input data and the logarithmic weighting coefficient and performing linearization by inverse transformation, the multiplication can be realized by the addition circuit. Therefore, the electronic circuit scale can be reduced despite multiple bits, and the logarithmic output data can be used as the input of the next layer by making the output be the logarithmic output data. As a result, it is possible to realize a neural network that can handle multi-bit data while reducing the electronic circuit scale.

### BRIEF DESCRIPTION OF THE DRAWINGS

FIG. 1A is a diagram for describing a neural network according to an embodiment, where it is a diagram illustrating a unit that models one neuron.

FIG. 1B is a diagram for describing a neural network according to an embodiment, where it is a diagram illustrating a state of a neural network in which a plurality of units are connected.

FIG. 2 is a block diagram illustrating a schematic configuration example of a neural network system according to an embodiment.

FIG. 3 is a block diagram illustrating an example of the neural electronic circuit illustrated in FIG. 2.

FIG. 4 is a block diagram illustrating an example of a process element column in FIG. 3.

FIG. 5 is a schematic diagram illustrating an example of the operation timing of the process element in FIG. 4.

FIG. 6A is a circuit diagram illustrating an example of a digital circuit of a process element illustrated in FIG. 2.

FIG. 6B is a circuit diagram illustrating an example of a digital circuit of an addition activation unit illustrated in FIG. 2.

FIG. 6C is a circuit diagram illustrating a modification example of the digital circuit of the process element.

FIG. 6D is a circuit diagram illustrating an example of a Max element illustrated in FIG. 6C.

FIG. 6E is a circuit diagram illustrating a modification example of a digital circuit of an addition activation unit.

FIG. 7 is a schematic diagram illustrating an example of the data relationship in a convolution operation.

FIG. 8 is a block diagram illustrating an example of a neural electronic circuit for realizing the convolution operation in FIG. 7.

FIG. 9 is a schematic diagram illustrating an example of a fully connected neural network.

FIG. 10 is a block diagram illustrating an example of a neural electronic circuit that realizes the fully connected neural network in FIG. 9.

FIG. 11 is a schematic diagram illustrating an example of intralayer expansion of a neural network.

FIG. 12 is a block diagram illustrating an example of a connection between core electronic circuits for realizing the intralayer expansion in FIG. 11.

FIG. 13 is a schematic diagram illustrating an example of increasing the number of layers of the neural network.

FIG. 14 is a block diagram illustrating an example of a connection between core electronic circuits for realizing the increase in the number of layers in FIG. 13.

FIG. 15A is a diagram illustrating a neural network circuit according to an embodiment, where it is a diagram illustrating a neural network corresponding to the neural network circuit.

FIG. 15B is a diagram illustrating a neural network circuit according to an embodiment, where it is a block diagram illustrating a configuration of the neural network circuit.

FIG. 15C is a diagram illustrating a neural network circuit according to an embodiment, where it is a truth table corresponding to the neural network circuit.

FIG. 16A is a diagram illustrating a detailed configuration of a neural network circuit according to an embodiment, where it is a diagram illustrating an example of a circuit of a memory cell according to the detailed configuration.

FIG. 16B is a diagram illustrating a detailed configuration of a neural network circuit according to an embodiment, where it is an example of a circuit of the detailed configuration.

FIG. 17A is a diagram illustrating a first example of a neural network integrated circuit according to an embodiment, where it is a diagram illustrating a neural network corresponding to the first example.

FIG. 17B is a diagram illustrating a first example of a neural network integrated circuit according to an embodiment, where it is a block diagram illustrating the configuration of the first example.

FIG. 18A is a diagram illustrating a second example of a neural network integrated circuit according to an embodiment, where it is a diagram illustrating a neural network corresponding to the second example.

FIG. 18B is a diagram illustrating a second example of a neural network integrated circuit according to an embodiment, where it is a block diagram illustrating the configuration of the second example.

FIG. 19A is a diagram illustrating a third example of a neural network integrated circuit according to an embodiment, where it is a diagram illustrating a neural network corresponding to the third example.

FIG. 19B is a diagram illustrating a third example of a neural network integrated circuit according to an embodiment, where it is a block diagram illustrating the configuration of the third example.

FIG. 20A is a diagram illustrating a fourth example of a neural network integrated circuit according to an embodiment, where it is a diagram illustrating a neural network corresponding to the fourth example.

FIG. 20B is a diagram illustrating a fourth example of a neural network integrated circuit according to an embodiment, where it is a block diagram illustrating the configuration of the fourth example.

FIG. 20C is a diagram illustrating a fourth example of a neural network integrated circuit according to an embodiment, where it is a block diagram illustrating an example of the configuration of a switch box according to the fourth example.

FIG. 21A is a diagram illustrating a part of a first example of a neural network integrated circuit according to a related form, where it is a diagram illustrating a neural network corresponding to the part.

FIG. 21B is a diagram illustrating a part of a first example of a neural network integrated circuit according to a related form, where it is a diagram illustrating a neural network corresponding to the part.

FIG. 21C is a diagram illustrating a part of a first example of a neural network integrated circuit according to a related form, where it is a truth table corresponding to the part.

FIG. 22A is a diagram illustrating a first example of a neural network integrated circuit according to a related form, where it is a diagram illustrating a neural network corresponding to the first example.

FIG. 22B is a diagram illustrating a first example of a neural network integrated circuit according to a related form, where it is a block diagram illustrating the configuration of the first example.

FIG. 23A is a diagram illustrating a first example of a neural network circuit according to a related form, where it is a diagram illustrating a neural network corresponding to the first example.

FIG. 23B is a diagram illustrating a first example of a neural network circuit according to a related form, where it is a block diagram illustrating the configuration of the first example.

FIG. 24A is a diagram illustrating a second example of a neural network integrated circuit according to a related form, where it is a diagram illustrating a neural network corresponding to the second example.

FIG. 24B is a diagram illustrating a second example of a neural network integrated circuit according to a related form, where it is a block diagram illustrating the configuration of the second example.

FIG. 25A is a diagram illustrating a third example of a neural network integrated circuit according to a related form, where it is a diagram illustrating a neural network corresponding to the third example.

FIG. 25B is a diagram illustrating a third example of a neural network integrated circuit according to a related form, where it is a block diagram illustrating the configuration of the third example.

FIG. 26A is a diagram illustrating a fourth example of a neural network integrated circuit according to a related form, where it is a block diagram illustrating the configuration of the fourth example.

FIG. 26B is a diagram illustrating a fourth example of a neural network integrated circuit according to a related form, where it is a diagram illustrating a circuit example corresponding to the fourth example.

FIG. 27A is a diagram illustrating a detailed configuration of a fourth example of a neural network integrated circuit according to a related form, where it is a diagram illustrating an example of a circuit such as a pipeline register according to the fourth example.

FIG. 27B is a diagram illustrating a detailed configuration of a fourth example of a neural network integrated circuit according to a related form, where it is a diagram illustrating an example of each of a majority determination input circuit and a serial majority determination circuit according to the fourth example.

FIG. 27C is a diagram illustrating a detailed configuration of a fourth example of a neural network integrated circuit according to a related form, where it is a diagram illustrating an example of a parallel majority determination circuit according to the fourth example.

FIG. 27D is a diagram illustrating a detailed configuration of a fourth example of a neural network integrated circuit according to a related form, where it is a timing chart showing an operation in the fourth example.

### MODES FOR CARRYING OUT THE INVENTION

Next, embodiments according to the present invention and related forms will be described with reference to the diagrams. In addition, the embodiments and the like described below are embodiments and the like in a case where the present invention is applied to a neural network circuit in which a neural network obtained by modeling a human brain function is realized by an electronic circuit.

### [1. Regarding Neural Network]

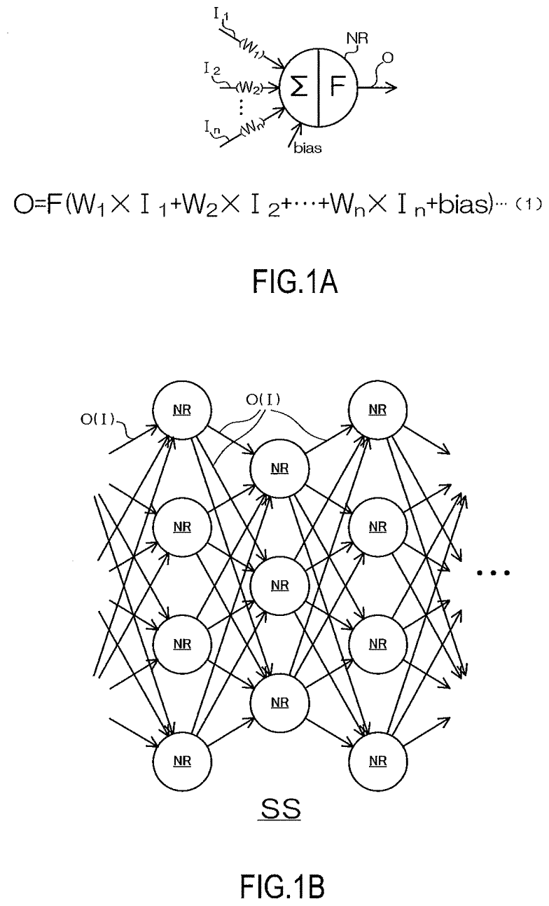

First, a neural network obtained by modeling the brain function will be generally described with reference to FIGS. 1A and 1B.

It is generally said that a large number of neurons (nerve cells) are present in the human brain. In the brain, each neuron receives electric signals from a large number of other neurons and transmits electric signals to a large number of other neurons. In addition, the brain is said to perform various kinds of information processing by transmitting these electric signals between the neurons. At this time, transmission and reception of electric signals between the neurons are performed through cells called synapses. In addition, the neural network is for realizing the brain function in a computer by modeling the transmission and reception of electric signals between the above neurons in the brain.

More specifically, in a neural network, as illustrated in FIG. 1A, multiplication processing on each of a plurality of input data I₁, input data I₂, . . . , and input data Iₙ (n is a natural number; the same hereinbelow) input from the outside, addition processing of each multiplication result and a bias (threshold value), and activation function application processing are performed by one neuron NR and the result is used as output data O, so that the transmission and reception of electric signals with respect to one neuron in the brain function are modeled. In addition, in the following description, the activation function application processing is simply referred to as “activation processing”. At this time, in one neuron NR, the multiplication processing is performed by multiplying the plurality of input data I₁, input data I₂, . . . , and input data Iₙ by a weighting coefficient W₁, a weighting coefficient W₂, . . . , and a weighting coefficient Wn set in advance (that, predetermined) corresponding to the plurality of input data I₁, input data I₂, . . . , and input data Iₙ.

Thereafter, the neuron NR performs the above addition processing for adding the value of a bias by adding the respective results of the multiplication processing on the input data I₁, input data I₂, . . . , and input data Iₙ. Then, the neuron NR performs the above activation processing for applying a predetermined activation function F to the result of the addition processing, and outputs the result to one or more other neurons NR as the output data O. The series of multiplication processing, addition processing, and activation processing described above are expressed by Equation (1) illustrated in FIG. 1A. At this time, the multiplication processing for multiplying the input data I₁, the input data I₂, . . . , and the input data Iₙ by the weighting coefficient W₁, the weighting coefficient W₂, . . . , and the weighting coefficient Wₙ corresponds to the action of the synapse in the exchange of the electric signal between the neurons NR and corresponds to an example of the “multiplication function” according to the present invention. In addition, the addition processing and the activation processing correspond to an example of the “addition/application function” according to the present invention. Then, as illustrated in FIG. 1B, a large number of respective neurons NR illustrated in FIG. 1A are collected and connected to each other by synapses, so that the entire brain is modeled as a neural network SS.

### [2. Outline of Configuration and Function of Neural Network System]

(2.1 Configuration and Function of Neural Network System)

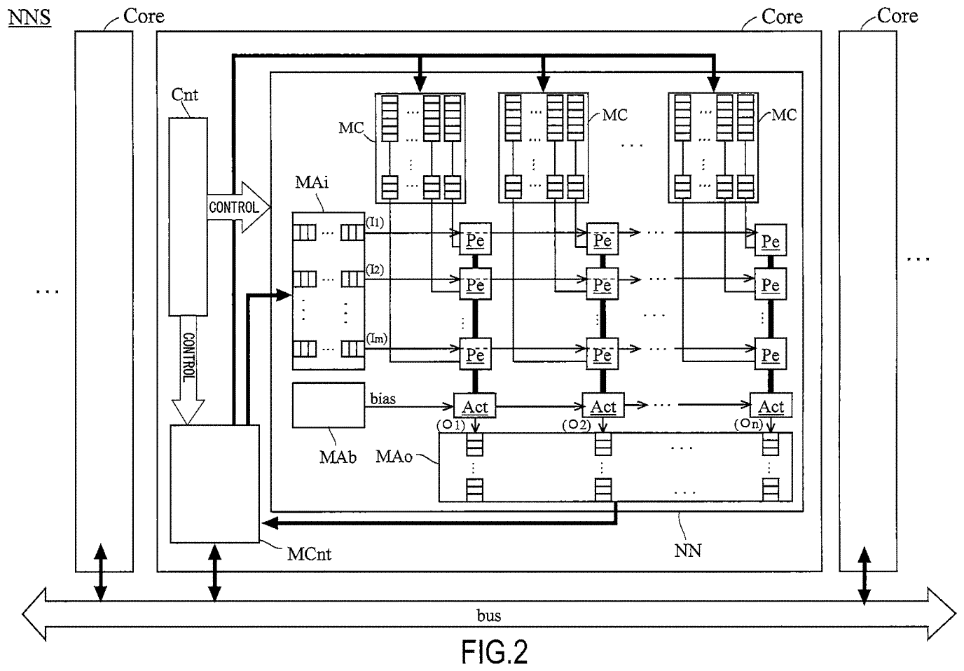

Next, the configuration and general function of a neural network system according to an embodiment of the present invention will be described with reference to FIG. 2.

FIG. 2 is a schematic diagram illustrating a schematic configuration example of a neural network system NNS according to the present embodiment.

As illustrated in FIG. 2, the neural network system NNS includes a plurality of core electronic circuits Core, which can realize various types of neural networks by electronic circuits, and a system bus that connects the core electronic circuits Core to each other.

The core electronic circuit Core has a neural electronic circuit NN capable of realizing various types of neural networks by electronic circuits, a memory access control unit MCnt for setting the weighting coefficient and the like of the neural electronic circuit NN, and a control unit Cnt that controls the neural electronic circuit NN and the memory access control unit MCnt. Here, as examples of various types of neural networks, a fully connected type neural network in which neurons between neuron layers are fully connected to each other, a neural network for performing a convolution operation, a neural network with intralayer expansion in a neuron layer, a neural network for increasing the number of layers, and the like can be mentioned.

The neural electronic circuit NN has: an input memory array unit MAi that sequentially supplies logarithmic input data, which is obtained by logarithmizing the input data I₁, . . . , and Iₙ, (m is a natural number; the same hereinbelow), in parallel; a memory cell array unit MC (an example of a storage unit) that sequentially supplies data of logarithmic weighting coefficients in parallel; a plurality of process element units Pe (an example of a first electronic circuit unit) that realize a multiplication function for multiplying the supplied input data I₁, . . . , and Iₘ by weighting coefficients and output multiplication results; an addition activation unit Act (an example of a second electronic circuit unit) that adds up the multiplication results of the pieces of parallel input data from the process element units Pe and applies an activation function to the addition result; an output memory array unit MAo that sequentially stores logarithmic output data obtained by logarithmizing output data O₁, . . . , and Oₙ (n is a natural number; the same hereinbelow) from each addition activation unit Act; and a bias memory array unit MAb that sequentially provides bias data to each addition activation unit Act.

The memory access control unit MCnt is, for example, a Direct Memory Access Controller. The memory access control unit MCnt sets logarithmic input data sequentially supplied to each process element unit Pe in the input memory array unit MAi under the control of the control unit Cnt. In addition, the memory access control unit MCnt sets a predetermined value, which indicates a weighting coefficient and the presence or absence of connection between neurons, in each memory cell array unit MC in advance under the control of the control unit Cnt. In addition, the memory access control unit MCnt extracts output data, which is output from the addition activation unit Act, from the output memory array unit MAo under the control of the control unit Cnt.

The control unit Cnt has a CPU (Central Processing Unit) and the like. The control unit Cnt measures the timing of synchronization or the like between respective elements of the neural electronic circuit NN, or takes a synchronization for calculation or data transfer. In addition, the control unit Cnt controls switching of selector elements, which will be described later, in the neural electronic circuit NN.

The control unit Cnt controls the memory access control unit MCnt to adjust data output from another core electronic circuit Core for the input memory array unit MAi, and performs control to supply the data to the input memory array unit MAi as logarithmic input data. The control unit Cnt controls the memory access control unit MCnt to transfer the logarithmic output data acquired from the output memory array unit MAo to another core electronic circuit Core.

In addition, a high-order controller (not illustrated) may control the neural network system NNS or the control unit Cnt of each core electronic circuit Core. In addition, the high-order controller may control the neural electronic circuit NN and the memory access control unit MCnt instead of the control unit Cnt. The high-order controller may be an external computer.

The bias memory array unit MAb stores in advance bias data to be provided to each addition activation unit Act.

(2.2 Configuration and Function of Neural Electronic Circuit)

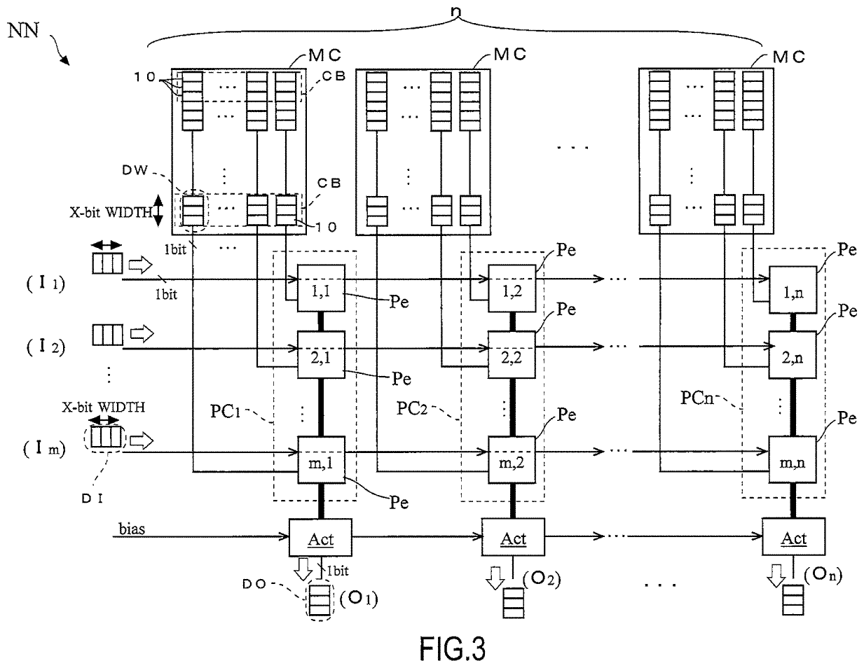

Next, the neural electronic circuit NN will be described with reference to FIG. 3.

FIG. 3 is a block diagram illustrating an example of the neural electronic circuit illustrated in FIG. 2.

As illustrated in FIG. 3, the neural electronic circuit NN realizes, for example, a two-layer neural network of m inputs×n outputs. The neural electronic circuit NN handles logarithmic input data whose value is expressed by X bits.

The memory cell array unit MC, which is an example of a storage unit, has a memory cell 10 that stores a weighting coefficient. The memory cell 10 stores a value of a logarithmized logarithmic weighting coefficient, which is set in advance based on the brain function realized by the neural network to be constructed, as one bit of “1” or “0” according to the value of each bit of data expressed by the X-bit width. A logarithmic weighting coefficient DW is configured by X (three in the diagram) memory cells 10. A sign bit indicating whether the value is positive or negative is assigned to the most significant bit or the least significant bit of the logarithmic weighting coefficient DW.

In addition, the memory cell array unit MC may have another memory cell for connection presence/absence information (not illustrated) that stores connection presence/absence information between neurons set in advance based on the above brain function for one logarithmic weighting coefficient DW. Here, non-connection information is, for example, a one-bit predetermined value meaning NC (Not Connected), and “1” or “0” is assigned as the predetermined value, for example.

The logarithmic weighting coefficients DW are lined up to form a column of memory cells. A memory cell block CB is formed by collecting the logarithmic weighting coefficients DW output to the respective process element units Pe at the same time. The logarithmic weighting coefficient DW of the memory cell block CB corresponds to each of pieces of input data that are input in parallel.

It is preferable that the memory cell array unit MC has the memory cell blocks CB the number of which is equal to or greater than the input parallel number m of pieces of input data I₁, . . . , and Iₘ input in parallel from the input memory array unit MAi. In the memory cell block CB, it is preferable that the number of memory cells 10 is equal to or greater than the number of cycles of serial input data sequentially input from the input memory array unit MAi by one bit.

The memory cell array unit MC outputs, for each memory cell block CB, an X-bit logarithmic weighting coefficient to the process element unit Pe corresponding to serial X-bit logarithmic input data that is sequentially input. The logarithmic weighting coefficient from the memory cell block CB and the logarithmic input data from the input memory array unit MAi are input to each process element unit Pe bit by bit so that encoded bits correspond thereto.

The memory cell block CB may alternately output the X-bit logarithmic weighting coefficient and the one-bit connection presence/absence information to the process element unit Pe in a sequential manner. The memory cell for information of connection/non-connection with the memory cell 10 may have an independent connection to the process element unit Pe, and may be separately and sequentially output to the process element unit Pe.

As illustrated in FIGS. 2 and 3, the memory cell array unit MC is arranged in the neural electronic circuit NN corresponding to the output parallel number n of pieces of output data, which are output in parallel to the output memory array unit MAo, and the output data O₁, . . . , and Oₙ output in parallel.

As described above, in the electronic circuit for realizing the brain function, the memory cell array unit MC functions as an example of a storage unit that stores a logarithmic weighting coefficient, in which a value obtained by logarithmizing a weighting coefficient corresponding to input data that is input is expressed in multiple bits, and outputs the logarithmic weighting coefficient bit by bit. The memory cell array unit MC functions as an example of a storage unit that stores the logarithmic weighting coefficient according to each of the pieces of parallel logarithmic input data that are input in parallel.

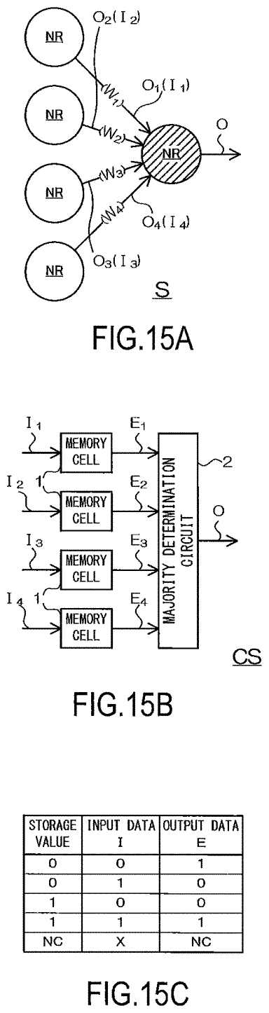

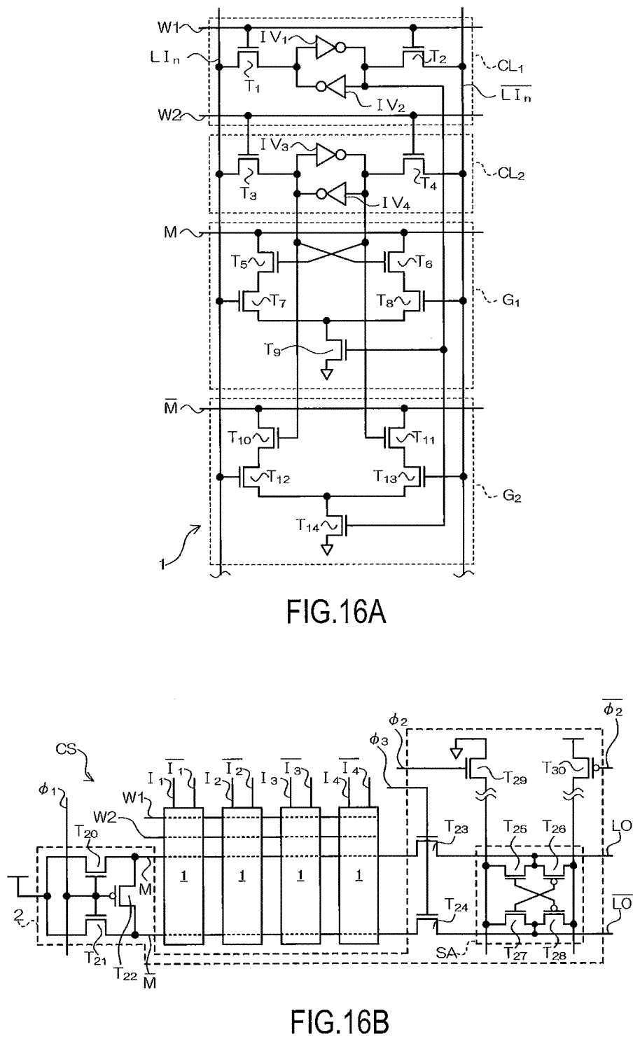

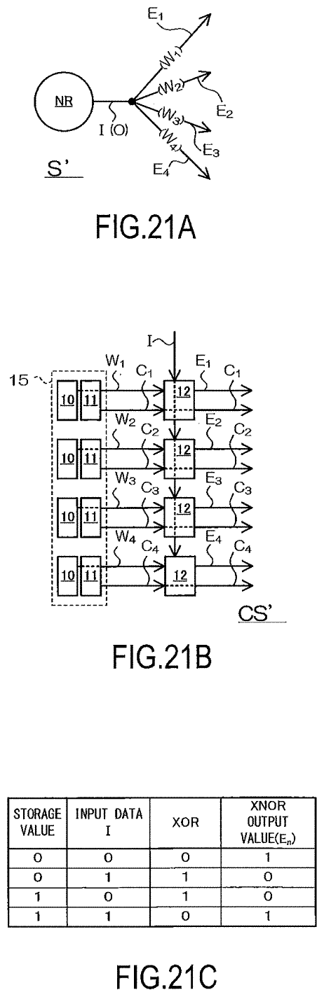

In addition, the details of the configurations and functions of the memory cell 10 and the memory cell block CB will be described later in description parts regarding the memory cell 1 in FIG. 15 and subsequent diagrams, in particular, FIGS. 15 and 16, description parts regarding the memory cell 10 in FIGS. 21 to 27 and the memory cell block 15 corresponding to the memory cell block CB, and the like. In addition, the memory cell array unit MC corresponds to a memory cell array MC1 and a memory cell array MC2 described later.

As illustrated in FIG. 3, the process element units Pe whose input parallel number arranged in pieces of parallel input data that are input in parallel is m form a process element column (for example, a process element column PC₁) in the neural electronic circuit NN. The process element columns PC₁ to PCₙ each having an output parallel number n are arranged in n columns in the neural electronic circuit NN corresponding to output data that is output in parallel. As illustrated in FIG. 3, the process element unit Pe is set as a two-dimensional operator array in m rows by n columns in the neural electronic circuit NN.

The process element units Pe of matrices (1, 1), (1, 2), . . . , and (1, n) are connected to each other so that logarithmic input data obtained by logarithmizing the input data I₁ is commonly input. The process element units Pe of matrices (2, 1), (2, 2), . . . , and (2, n) are connected to each other so that the input data I₂ is commonly input. The process element units Pe of matrices (m, 1), (m, 2), . . . , and (m, n) are connected to each other so that logarithmic input data obtained by logarithmizing the input data Iₘ is commonly input.

The process element unit Pe receives logarithmic input data, in which the logarithmic value of input data is expressed in multiple bits, from the input memory array unit MAi bit by bit. The process element unit Pe receives the logarithmic weighting coefficients output from the memory cell array unit MC bit by bit. In addition, the logarithmic input data and the logarithmic weighting coefficients are input to the process element unit Pe so that their respective bits (sign bits or digits) in the X bits correspond to each other.

The process element unit Pe calculates a logarithmic addition by adding up the logarithmic input data and the logarithmic weighting coefficient, and calculates a multiplication result by linearizing the logarithmic addition result by inverse logarithmic transformation.

In addition, when the non-connection information (for example, a predetermined value meaning “NC”) is output from the memory cell for connection presence/absence information, the multiplication result may not be added in the addition activation unit Act. For example, the multiplication result and the connection presence/absence information may be alternately output in pairs. In addition, regarding the connection presence/absence information, from the process element unit Pe to the addition activation unit Act, there may be a connection independent of the multiplication result so that the multiplication result and the connection presence/absence information are output separately from each other.

In addition, when the process element unit Pe calculates a partial sum of multiplication results, in a case where non-connection information (for example, a predetermined value meaning “NC”) is output from the memory cell for connection presence/absence information, there may be no addition to the partial sum of multiplication results.

As described above, the process element unit Pe functions as an example of the first electronic circuit that outputs a multiplication result of the input data and the weighting coefficient. The process element unit Pe functions as an example of the first electronic circuit unit that receives logarithmic input data, in which the logarithmic value of the input data is expressed in multiple bits, bit by bit, calculates a logarithmic addition by adding up the logarithmic input data and the logarithmic weighting coefficient output from the storage unit, and calculates the multiplication result by linearizing the logarithmic addition result.

The process element columns PC₁, . . . , and PCₙ output, for example, partial sum results, each of which is obtained by adding the multiplication results from the respective process element units Pe or some of the multiplication results, to the addition activation unit Act.

As illustrated in FIGS. 2 and 3, the addition activation units Act are arranged according to the output data O₁, . . . , and Oₙ that is output in parallel.

The addition activation unit Act adds up the multiplication results sequentially output from the process element column, applies an activation function to the addition result, and outputs logarithmic output data of multiple bits to the output memory array unit MAo. When the process element unit Pe outputs the partial sum of the multiplication results, the addition activation unit Act adds up the multiplication results sequentially output from the process element column, applies an activation function to the addition result, and outputs the logarithmic output data to the output memory array unit MAo bit by bit.

In the process element column, the addition activation unit Act outputs logarithmic output data obtained by applying the activation function to a value obtained by adding the bias, which indicates a threshold value of a neuron, to the addition result obtained by adding the multiplication results in X cycle units of X-bit logarithmic input data.

As described above, the addition activation unit Act functions as an example of the second electronic circuit that realizes addition and application functions for adding up the multiplication results from the first electronic circuit units, applying an activation function to the addition result, and outputting logarithmic output data. The addition activation unit Act functions as an example of the second electronic circuit that applies an activation function to a logarithmic addition result, which is obtained by logarithmizing the addition result, and outputs the logarithmic output data.

As illustrated in FIG. 3, parallelization of X-bit serial input is performed so that the row of the process element units Pe is shared for the logarithmic input data, and each process element column that is a column of the process element units Pe independently outputs logarithmic output data.

(1.3 Configuration and Function of Process Element Column)

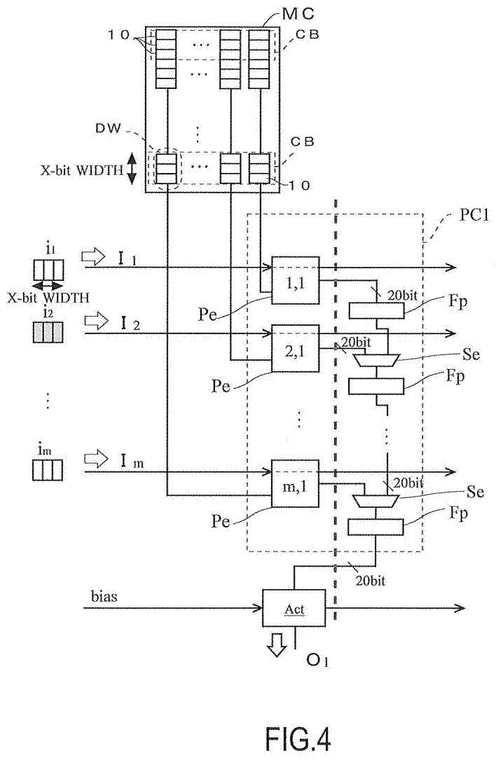

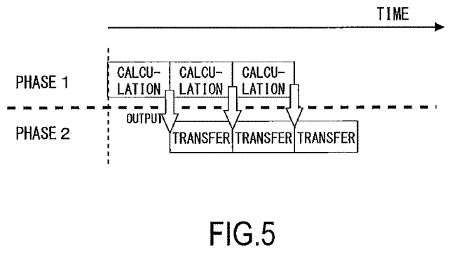

Next, the configuration and function of a process element column will be described with reference to FIGS. 4 and 5.

FIG. 4 is a block diagram illustrating an example of the process element column in FIG. 3. FIG. 5 is a schematic diagram illustrating an example of the operation timing of the process element in FIG. 4.

As illustrated in FIG. 4, a process element column, such as the process element column PC₁ has a plurality of process element units Pe that perform calculation as phase 1 and a plurality of flip-flops Fp (an example of a temporary storage unit) and selectors Se of phase 2 for transferring the calculation result in the phase 1.

The flip-flop Fp is connected to the output side of each process element unit Pe, and temporarily stores the multiplication result or the partial sum result of the process element unit Pe. The flip-flops Fp are connected in series through the selectors Se corresponding to the process element unit Pe in the first row to the process element unit Pe in the n-th row. The flip-flop Fp in the n-th row is connected to the addition activation unit Act. In addition, these connections are examples of the functions of portions shown by thick lines between the process element units Pe in FIG. 2.

The selector Se is arranged between the process element units Pe for switching between the data from the upstream flip-flop Fp and the data from the process element unit Pe.

As illustrated in FIG. 5, in the phase 1, a calculation such as multiplication is performed in each flip-flop Fp, the selector Se selects the data of the flip-flop Fp on the input side, and the calculation result is output to the flip-flop Fp. Then, in the phase 2, the selector Se selects the data of the upstream flip-flop Fp. In this manner, the calculation result is sequentially transferred to the addition activation unit Act at the timing of a cycle unit of the input parallel number m, so that the calculation result is transferred.

As described above, the flip-flop Fp functions as an example of a temporary storage unit that temporarily stores the multiplication result from each of the first electronic circuit units for each of the first electronic circuit units. The flip-flops Fp are set in series, and function as an example of a temporary storage unit that sequentially transfers the multiplication result to the second electronic circuit unit.

In addition, the multiplication result from each process element unit Pe may be directly supplied to the addition activation unit Act.

(2.4 Circuit Configurations of Process Element and Addition Activation Unit)

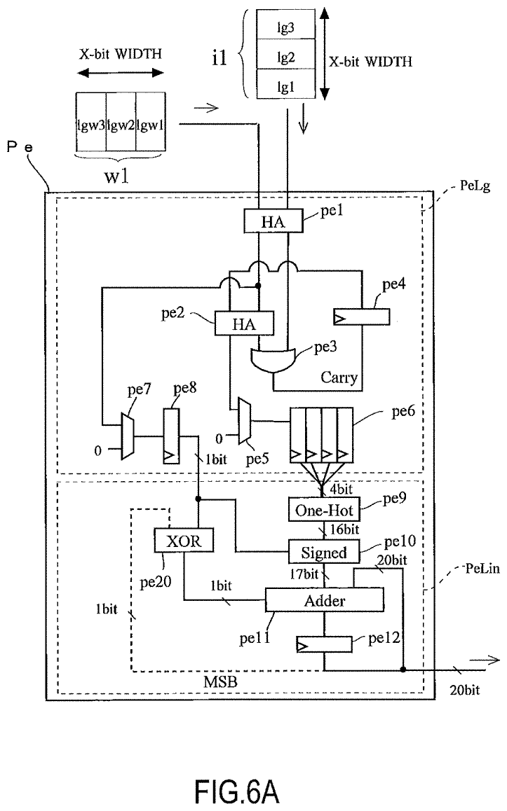

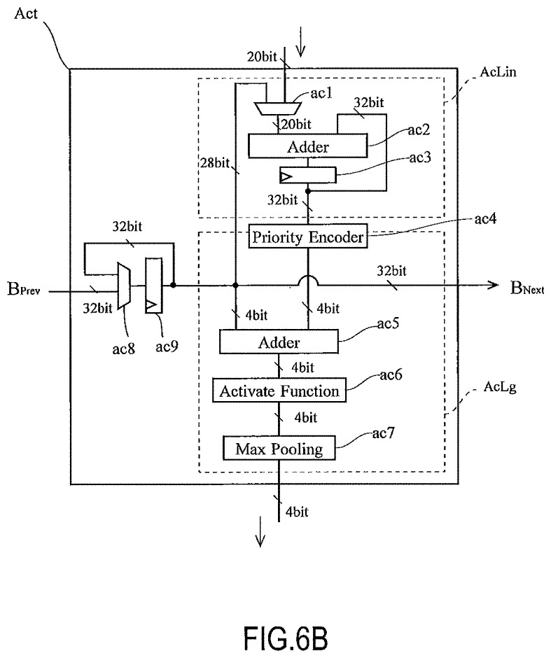

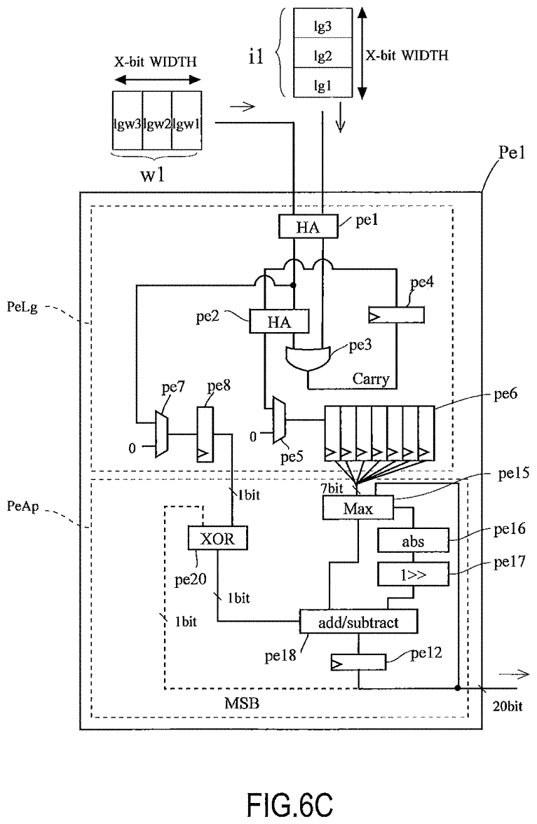

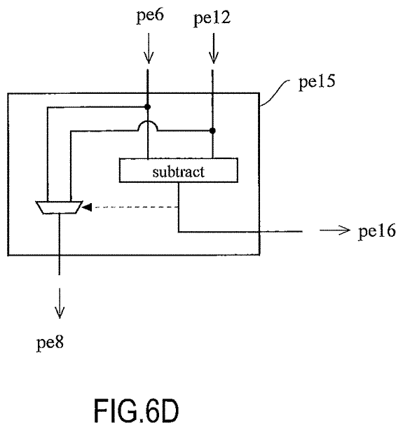

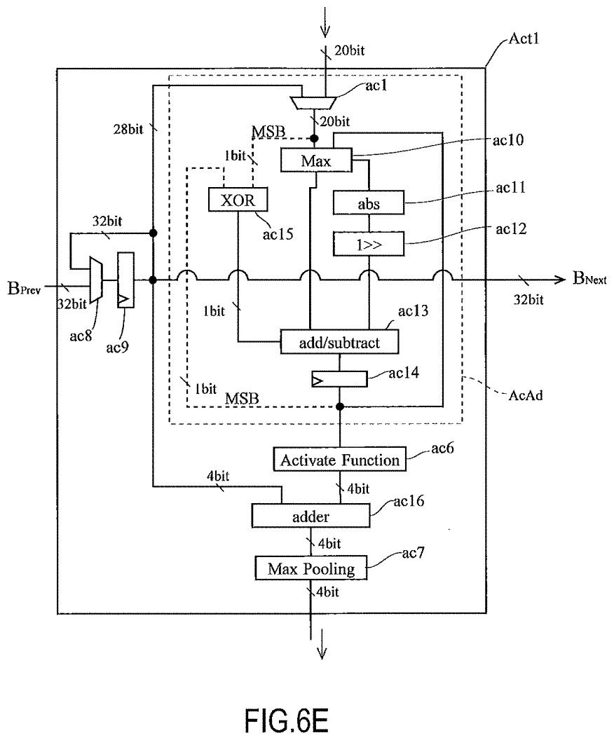

Next, the circuit configurations of the process element and the addition activation unit will be described with reference to FIGS. 6A and 6B.

As illustrated in FIG. 6A, the process element unit Pe has a log addition unit PeLg that calculates a logarithmic addition by adding up logarithmic input data and a logarithmic weighting coefficient and a linear unit PeLin that calculates a partial sum of multiplication result by linearizing the logarithmic addition.

The log addition unit PeLg has a half adder (HA) pe1, a half adder pe2, an OR element pe3, a flip-flop pe4, a selector pe5, a shift register pe6 in which flip-flops are connected in series, a selector pe7, and a flip-flop pe8.

The half adder pe1, the half adder pe2, and the OR element pe3 form a full adder. The shift register pe6 temporarily stores the value obtained by addition. The selector pe7 and the flip-flop pe8 output, to the linear unit PeLin, information of the sign of the result obtained by adding up the signs of the logarithmic input data and the logarithmic weighting coefficient by the half adder pe1. In addition, it is preferable that the number of shift registers pe6 connected in series is equal to or greater than the number of input bits+1.

The values of bits lg1, lg2, lg3 of the logarithmic input data and the values of bits lgw1, lgw2, lgw3 of the logarithmic weighting coefficient are sequentially input to the log addition unit PeLg. A sign bit is assigned to the first bit (lg1, lgw1), and bits corresponding to respective digits are first input to the half adder pe1 of the log addition unit PeLg collectively. The selector pe5 selects “0” at a timing at which the sign bit is input. The selector pe7 selects “0” at a timing at which no sign bit is input, and only the sign bit is fetched by the selector pe8 to determine the sign. In addition, the sign bit may be assigned to the last bit. In addition, bits other than the sign bit indicate absolute values.

The half adder pe1, the half adder pe2, the OR element pe3, and the flip-flop pe4 add bit data other than the sign bit by bit, and the logarithmic addition result of the bits is sequentially shifted and stored in the shift register pe6.

The linear unit PeLin has a One-Hot element pe9, a coding element (Signed) pe10, an adder (Adder) pe11, a flip-flop pe12, and an XOR element pe20.

The One-Hot element pe9 is a circuit for outputting only the bit position of the input value, which was initially 1 in the input bit string, as 1 and outputting the others as 0, that is, setting only the most significant bit to 1 and setting the others to 0. The One-Hot element pe9 has a function of extracting each bit of the logarithmic addition result stored in the shift register pe6 and performing inverse logarithmic transformation for linearization.

The coding element pe10 is a circuit that takes the 2's complement for the value linearized by the One-Hot element pe9, based on the sign of the logarithmic input data from the selector pe7 and the flip-flop pe8, so that addition and subtraction can be performed by the adder pe11.

The adder pe11 adds up the previous value temporarily stored in the flip-flop pe12 and the output value of the coding element pe10. The addition result of the adder pe11 is stored in the flip-flop pe12. For example, the adder pe11 and the flip-flop pe12 loop by the parallel number of pieces of input data and output the partial sum of the multiplication result.

The flip-flop pe12 temporarily stores the bits (for example, 20 bits) of the output of the adder pe11.

The XOR element pe20 is used when the bit width of the input to the process element unit Pe is 1 (X=1). In this case, the input data to the process element unit Pe corresponds only to the sign bit. That is, “0” or “1” corresponds to (0, 1)=(+1, 1). In terms of a circuit, only the sign bit of the flip-flop pe8 is used. Therefore, the flip-flop pe12 determines the sign of the adder pe11 and the sign of the flip-flop pe8, and the XOR element pe20 determines whether the adder pe11 serving as a counter increments the count by +1 or −1. In addition, in the diagram, the broken line indicates one bit. The most significant bit, that is, the sign bit is extracted from the 20 bits of the flip-flop pe12.

Next, the circuit configuration of the addition activation unit Act will be described with reference to FIG. 6B.

As illustrated in FIG. 6B, the addition activation unit Act has a linear unit AcLin that adds partial sums of the linearized multiplication results from the respective process element units Pe and a log unit AcLg that applies an activation function to the addition result to output logarithmic output data.

The linear unit AcLin has a selector ac1, an adder ac2, and a flip-flop ac3.

The selector ac1 controls the input to the adder ac2. The selector ac1 receives data (for example, 20 bits) from the process element columns PC₁, . . . , and PCₙ, and performs control to finally add the value of the bias from the flip-flop ac9 by the adder ac2.

Addition is performed by the adder ac2 and the flip-flop ac3, and the addition result data (for example, 32 bits) is output to the log unit AcLg.

The log unit AcLg has a logarithmic converter ac4, an adder ac5, an activation function unit ac6, and a maximum pooler ac7.

The logarithmic converter ac4 is a Priority Encoder that performs a search from the most significant bit and outputs a number at the first position of “1”. The logarithmic converter ac4 outputs the maximum bit position, which is 1 in the addition result data (for example, 32 bits) in, for example, a four-bit binary number, that is, in log expression.

The adder ac5 adds up the logarithmic value of four bits branched from the signal of the bias bias from the flip-flop ac9 and the output from the logarithmic converter ac4. In addition, the adder ac5 has a multiplication function in terms of numerical expression since addition in log expression is performed. In addition, the adder ac5 may output four bits, assuming that there is no carry. The signal branched from the signal of the bias bias is preliminarily expressed by a log and serves as a multiplication for scaling the output result.

The activation function unit ac6 realizes a step function, a sigmoid function, a ramp function, and the like. The activation function unit ac6 has a conversion table that stores a correspondence table from the addition result to the activation function, and realizes an activation function. The value of the conversion table is set in advance by the memory access control unit MCnt for the addition activation unit Act, for example.

The maximum pooler ac7 has a function of receiving a plurality of output results and selecting only one piece of data. The maximum pooler ac7 has a register (for example, four bits), and compares the previous value with the current input value and outputs the larger one. The maximum pooler ac7 transmits information of the neuron with the strongest reaction, thereby enabling robust inference with a small amount of calculation. In addition, when this function is not used, the addition activation unit Act may be constructed so as to spool the maximum pooling function.

In addition, the selector ac8 and the flip-flop ac9 control whether to transfer the value of the bias bias output from the bias memory array unit MAb to the next addition activation unit Act or to hold the value of the bias bias. After the value of the bias bias is set, the value of the bias bias is held. However, when the value of the bias bias is initially set or needs to be changed, the value of the bias bias is transferred.

In addition, the addition of the signal from the bias bias in the adder ac2 of the linear unit AcLin serves as bias, and the log addition in the adder ac5 of the log unit AcLg serves as scale multiplication.

(2.5 Modification Examples of Circuit Configurations of Process Element and Addition Activation Unit)

Next, modification examples of the circuit configurations of the process element and the addition activation unit will be described with reference to FIGS. 6C to 6E. In addition, the same reference numerals are used for the same or corresponding portions as in the above-described embodiment, and only different configurations and operations will be described. The same applies to the other embodiments and modification examples.

As illustrated in FIG. 6C, the process element unit Pe1 has a log addition unit PeLg that calculates a logarithmic addition by adding up logarithmic input data and a logarithmic weighting coefficient and an approximation unit PeAp that calculates a partial sum of multiplication results by a function approximate expression (for example, Maclaurin expansion or Taylor expansion).

The approximation unit PeAp has a Max element pe15, an abs element pe16, a one-bit shift element pe17, an adder/subtractor pe18, a flip-flop pe12, and an XOR element pe20. The approximation unit PeAp performs approximate calculation in a logarithmic form.

As illustrated in FIG. 6D, the Max element pe15 first performs a subtraction on two inputs from the shift register pe6 and the flip-flop pe12, determines which of the two inputs is to be output using the result (the most significant sign bit) by the selector, and outputs the determination result to the adder/subtractor pe18. In addition, since the abs element pe16 also needs the value of the difference between the two inputs, the result of the subtraction is also output to the abs element pe16. That is, the result of the subtraction in the Max element pe15 is output to the abs element pe16, and the larger value determined using the result is output to the adder/subtractor pe18. In the expression of Maclaurin expansion, the larger value of two inputs and the power of 2 of the absolute value of the difference are added or subtracted according to the sign.

Next, the circuit configuration of the addition activation unit Act1 will be described with reference to FIG. 6E.

As illustrated in FIG. 6E, the addition activation unit Act1 has an approximation unit AcAd or the like that adds partial sums of multiplication results of the function approximate expression from the process element units Pe1.

The approximation unit AcAd is formed by an element similar to the approximation unit PeAp, and has a configuration in which the approximation unit PeAp is added to the selector ac1 that switches between the input from the process element unit Pe1 and the bias input. That is, the approximation unit AcAd has a function of the function approximate expression and a circuit (XOR element ac15 corresponding to the XOR element pe20) when the input data has a value of one bit.

As the function of the function approximate expression, the approximation unit AcAd has a Max element ac10 corresponding to the Max element pe15, an abs element ac11 corresponding to the abs element pe16, a one-bit shift element ac12 corresponding to the one-bit shift element pe17, an adder/subtractor ac13 corresponding to the adder/subtractor pe18, and a flip-flop ac14 corresponding to the flip-flop pe12.

With the function approximate expression, the approximation unit AcAd adds a partial sum from the process element unit Pe1 and finally adds the value of the bias bias from the flip-flop ac9.

The activation function unit ac6 of the addition activation unit Act1 applies an activation function to the output of the approximation unit AcAd.

The adder ac16 adds up the output of the activation function unit ac6 and the logarithmic value of four bits branched from the signal of the bias bias from the flip-flop ac9, and performs log multiplication (adder) of the bias and the scale constant held in the flip-flop ac9. The adder act 6 outputs logarithmic output data. In addition, the adder ac16 may be provided before the activation function unit ac6 of the addition activation unit Act1 like the adder ac5 of the addition activation unit Act.

When the function of the maximum pooler ac7 of the addition activation unit Act1 is not used like the maximum pooler ac7 of the addition activation unit Act, the addition activation unit Act1 may be constructed so as to spool the maximum pooling function.

### [3. Application Examples of Neural Electronic Circuit]

Next, examples for realizing various types of neural networks by the neural electronic circuit NN will be described.

(3.1 Neural Electronic Circuit for Realizing Convolution Operation)

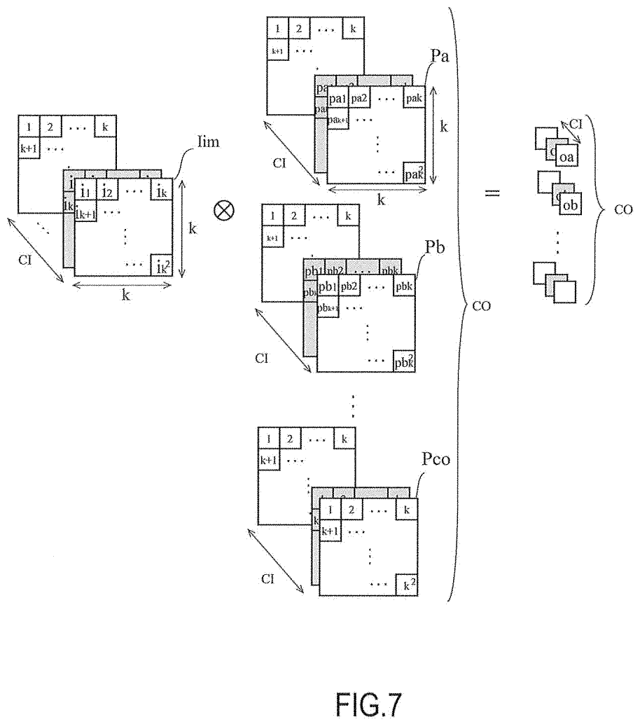

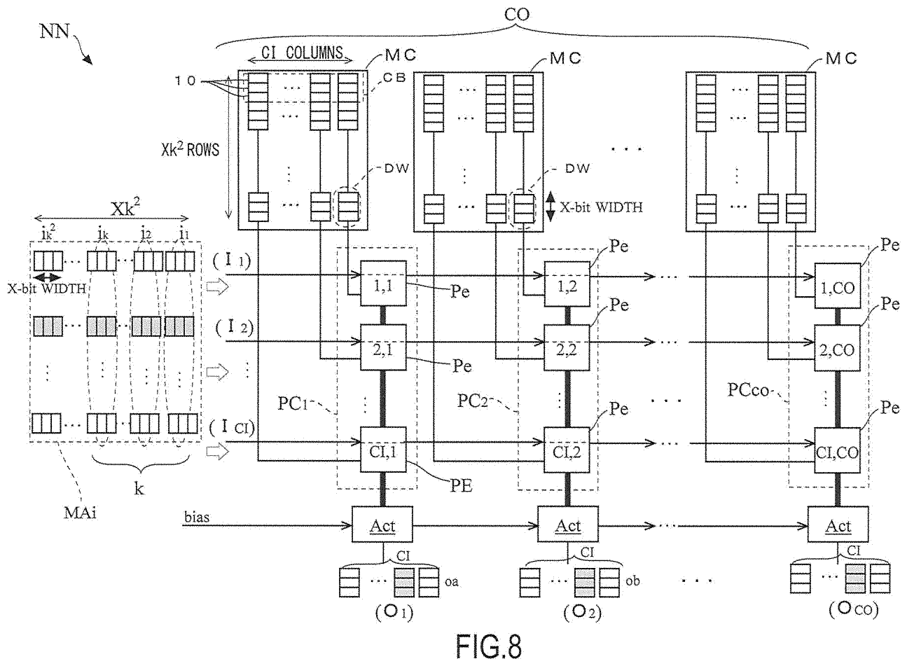

Next, a neural electronic circuit for realizing the convolution operation will be described with reference to FIGS. 7 and 8.

FIG. 7 is a schematic diagram illustrating an example of the data relationship in the convolution operation. FIG. 8 is a block diagram illustrating an example of a neural electronic circuit for realizing the convolution operation in FIG. 7.

As illustrated in FIG. 7, a convolution operation is performed on input data of input images Iim corresponding to the number of channels CI and filter data of filter images Pₐ, P_{b}, . . . , and P_{CO} corresponding to the number of types CO. Here, in the case of a color image, such as RGB, the number of channels is three. In the case of a monochrome image, the number of channels is one. In the case of a CMYK color model image, the number of channels is four.

As illustrated in FIG. 7, for the input image Iim of k×k pixels having a value of multiple bits, individual input data i₁, i₂, . . . , iₖ, . . . , iₖ² are formed. In addition, a region of k×k pixels is sequentially cut out from the original image, and a convolution operation is performed on the original image. Here, the convolution operation is a binomial operation in which the first function is superimposed on the second function while being moved in parallel. For example, the input image Iim corresponds to the first function, and the filter image corresponds to the second function.

Here, in FIG. 7, the input data I₁ is a general term for the input data of the channel 1, and the input data i₁, i₂, . . . , iₖ, . . . , iₖ² are individual input data of multiple bits sequentially input to the channel 1. The input data I₂ is a general term for the input data of the channel 2, and the input data i₁, i₂, . . . , iₖ, . . . , iₖ² indicated by gray boxes are individual input data of multiple bits sequentially input to the channel 2.

The filter data is k×k pixel filter images Pₐ, P_{b}, . . . , and P_{CO} having a value of multiple bits corresponding to the input image Iim. In the case of color, for example, a set of element images for three channels is prepared, and filter images corresponding to the number of types of CO are prepared.

From one k×k pixel input image Iim and one k×k pixel filter image (for example, one filter image Pₐ), output data of multiple bits is output by the convolution operation. With respect to the one-bit output data for each of CI channels, CI×CO output data corresponding to the CO types of filter images is generated.

As illustrated in FIG. 8, the neural electronic circuit NN includes process element columns PC₁, PC₂, . . . , and PC_{co}, in which the process element units Pe corresponding to the number of channels are arranged, and memory cell array units MC corresponding to the CO types of filter images. The control unit Cnt performs control to use the process element columns PC₁, PC₂, . . . , and PC_{co} and the CO memory cell array units MC in the neural electronic circuit NN.

The memory access control unit MCnt sets a value of multiple bits corresponding to k×k pixels of the filter image, as a weighting coefficient, in the memory cell 10 of the memory cell column of the memory cell array unit MC.

The memory access control unit MCnt sets logarithmic input data, in which k² pieces of input data i₁, i₂, . . . , iₖ, . . . , iₖ² each having an X bit width are logarithmized for each channel, in the input memory array unit MAi. Here, for example, logarithmic input data of the input data i₁ is expressed in X bits (for example, lg1, lg2, and lg3 in three-bit expression).

First, the neural electronic circuit NN sequentially processes input data corresponding to the number of channels CI.

Specifically, each bit value of the X-bit expression of the logarithmic input data of the input data i₁, i₂, . . . , and i_{CI} among the pieces of input data I₁ of the channel 1, is sequentially input to each process element unit Pe of matrices (1, 1), (1, 2), . . . , and (1, CO).

In synchronization with the input of each bit of the X-bit expression of the logarithmic input data of the input data i₁, i₂, . . . , and i_{CI}, each bit value of the X-bit expression of the logarithmic weighting coefficient obtained by logarithmizing each of weighting coefficients w₁, w₂, . . . , and w_{CI} of multiple bit values output from the memory cell array unit MC is also sequentially input to the process element unit Pe of the matrix (1, 1). Here, for example, the logarithmic input data of the weighting coefficient wₜ is expressed in X bits (for example, lgw1, lgw2, and lgw3 in three-bit expression).

As described above, the memory cell array unit MC functions as an example of a storage unit that sequentially outputs logarithmic weighting coefficients, which correspond to the logarithmic input data sequentially input to the first electronic circuit unit, to the first electronic circuit units bit by bit.

As illustrated in FIG. 5, in the phase 1, in the process element column PC₁, the process element unit Pe of the matrix (1, 1) calculates multiplication results i₁×w₁, i₂×w₂, . . . , and i_{CI}×w_{CI} by the logarithmic sum, and performs linearization to calculate a partial sum i₁×w₁+i₂×w₂+ . . . +i_{CI}×w_{CI} of the channel 1, which is the sum of CI channels. The partial sum i₁×w₁+i₂×w₂+ . . . +i_{CI}×w_{CI} is an example of the partial addition result obtained by adding up the multiplication results by the input parallel number of pieces of input data that are input in parallel.

Among the pieces of input data I2 of the channel 2, logarithmic input data of the input data i₁, i₂, . . . , and i_{CI} shown by gray squares in FIG. 8 are sequentially input to each process element unit Pe of matrices (2, 1), (2, 2), . . . , and (2, CO). The process element unit Pe of the matrix (2, 1) calculates a multiplication result by the logarithmic sum for the logarithmic input data of the input data I₂ of the channel 2, and performs linearization to calculate a partial sum of the channel 2.

Regarding the channel CI as well, the process element unit Pe of the matrix (CI, 1) calculates a multiplication result by the logarithmic sum for the logarithmic input data of input data ICI of the channel CI, and performs linearization to calculate the partial sum.

As described above the process element unit Pe functions as an example of the first electronic circuit unit that outputs a partial addition result obtained by adding the multiplication results by the input parallel number of pieces of the logarithmic input data that are input in parallel.

Then, in the phase 2, the process element column PC₁ sequentially transfers a partial sum for each channel, which is output from each process element unit Pe of the matrices (1, 1), (2, 1), . . . , and (CI, 1), to the addition activation unit Act.

In the next calculation of phase 1, the process element unit Pe of the matrix (1, 1) calculates multiplication results i_{CI+1}×w_{CI+1}, i_{CI+2}×w_{CI+2}, . . . , and i_{2CI}×w_{2CI} by the logarithmic sum for the logarithmic input data of input data i_{CI+1}, i_{CI+2}, . . . , and i_{2CI}, and performs linearization to calculate a partial sum i_{CI+1}×w_{CI+1}+i_{CI+2}×w_{CI+2}+ . . . +i_{2CI}×w_{2CI}.

For input data corresponding to the number of channels CI until the k²-th input data, the multiplication result and the partial sum may be calculated and transferred. A serial input in X×k² cycle units is formed for an input image of k×k pixels, and is output by one pixel as an X-bit value for each filter image.

The process element column PC₂ and the like similarly calculate a partial sum and transfer the partial sum to the addition activation unit Act.

The addition activation unit Act calculates the sum of partial sums for each channel, and calculates the total sum for k² pieces of input data as the result of the convolution operation. The addition activation unit Act adds the value of the bias, which is a threshold value, to the weighted sum of the input data, logarithmizes the result and applies the activation function, and outputs the result to the output memory array unit MAo as logarithmic output data obtained by logarithmizing output data Ooa of a four-bit value and the like. The output result for the input image Tim and the filter image Pa is output data oa. The output result of the input image Iim and the filter image Pb is output data ob. Output data is calculated for each channel. In addition, the output data oa and the like may be set as a result of the convolution operation.

As described above, the addition activation unit Act functions as an example of the second electronic circuit that calculates the addition result from the partial addition result.

The output memory array unit MAo stores, as one word, logarithmic output data of the output data oa, . . . corresponding to the number of channels CI. The output memory array unit MAo stores logarithmic output data of 1-word output data oa, . . . , logarithmic output data of 1-word output data ob, . . . for each of the filter images Pₐ, P_{b}, . . . , and P_{CO}.

(3.2 Neural Electronic Circuit that Realizes a Fully Connected Neural Network)

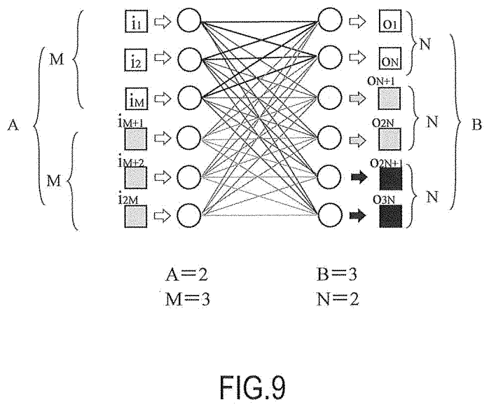

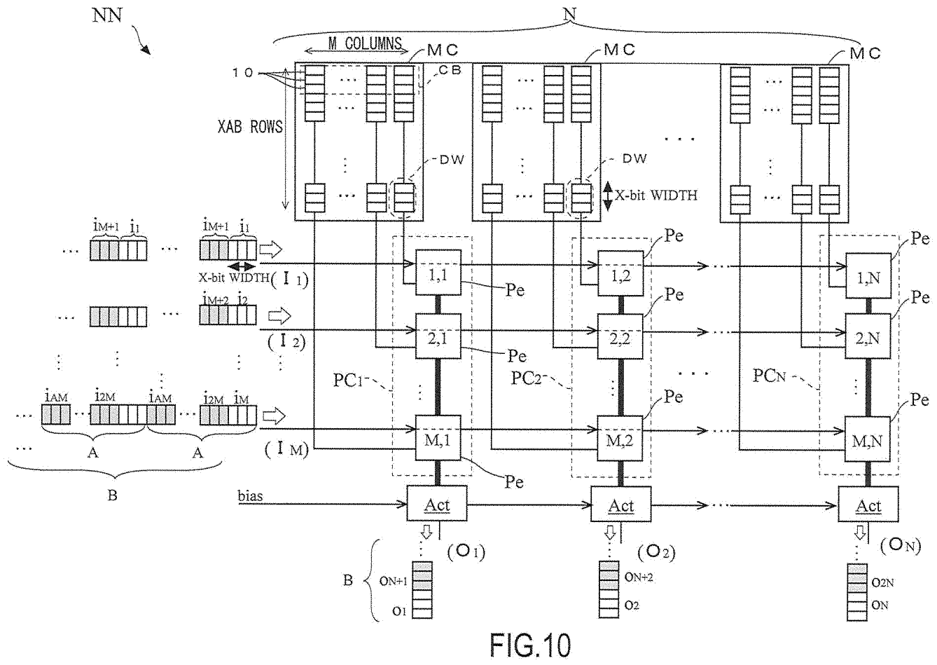

Next, a neural electronic circuit that realizes a fully connected neural network in which neurons between neuron layers are fully connected will be described with reference to FIGS. 9 and 10.

FIG. 9 is a schematic diagram illustrating an example of a fully connected neural network. FIG. 10 is a block diagram illustrating an example of a neural electronic circuit that realizes the fully connected neural network in FIG. 9.

A case will be described in which the M×N neural electronic circuit NN realizes a fully connected neural network having an input parallel number M or more and an output parallel number N or more. For example, FIG. 9 illustrates an example of M=3, N=2, A=2, and B=3 in a fully connected neural network of AM×BN.

As illustrated in FIG. 10, the neural electronic circuit NN has a process element column in which the process element units Pe corresponding to the input parallel number M are arranged, process element columns PC₁, PC₂, . . . , and PC_{N} corresponding to the output parallel number N, and the memory cell array units MC corresponding to the output parallel number N. The control unit Cnt performs control to use the process element columns PC₁, PC₂, . . . , and PC_{N} and the N memory cell array units MC in the neural electronic circuit NN. Here, the input parallel number M is an example of the inputtable parallel number, and the output parallel number N is an example of the outputtable parallel number.

The memory access control unit MCnt sets logarithmic input data in which the pieces of input data i₁, i₂, . . . , and i_{M} each having an X-bit width are logarithmized in parallel, sets logarithmic input data in which the next i_{M+1}, i_{M+2}, . . . , and i_{2M} are logarithmized, and successively sets logarithmic input data of up to input data i_{AM} in the input memory array unit MAi. The memory access control unit MCnt repeats the above B times from the input data i₁ to the input data i_{AM} to set the data in the input memory array unit MAi.

The memory access control unit MCnt sets X-bit values of A×B weighting coefficients in advance in the memory cells 10 in the memory cell column of the memory cell array unit MC. For example, the memory access control unit MCnt sets weighting coefficients in the memory cells 10 in the column of memory cells of the memory cell array unit MC by repeating logarithmic input data of weighting coefficients w₁, w_{M+1}, w_{2M+1}, . . . , and w_{(A-1)M+1} B times corresponding to the logarithmic input data of the input data i₁, i_{M+1}, i_{2M+1}, . . . , and i_{(A-1)M+1}.

First, the neural electronic circuit NN performs parallel processing on the logarithmic input data of the input data corresponding to the input parallel number M.

Specifically, each bit value of the X-bit expression of the logarithmic input data of the input data i₁ is input to each process element unit Pe of the matrices (1, 1), (1, 2), . . . , and (1, N). Each bit value of the X-bit expression of the logarithmic input data of the input data i₂ is input to each process element unit Pe of the matrices (2, 1), (2, 2), . . . , and (2, N). Each bit value of the X-bit expression of the logarithmic input data of the input data iM is input to each process element unit Pe of the matrices (M, 1), (M, 2), . . . , and (M, N).

In synchronization with the input of each bit of the X-bit expression of the logarithmic input data of the input data i₁, each bit value of the X-bit expression of the logarithmic weighting coefficient obtained by logarithmizing the weighting coefficient w1 of a multiple bit value output from the memory cell array unit MC is also input to the process element unit Pe of the matrix (1, 1). In synchronization with the input of each bit of the X-bit expression of the logarithmic input data of the input data i₂, each bit value of the X-bit expression of the logarithmic weighting coefficient obtained by logarithmizing the weighting coefficient w₂ output from the memory cell array unit MC is also input to the process element unit Pe of the matrix (2, 1). In synchronization with the input of each bit of the X-bit expression of the logarithmic input data of the input data i_{M}, each bit value of the X-bit expression of the logarithmic weighting coefficient obtained by logarithmizing the weighting coefficient w_{M} output from the memory cell array unit MC is also input to the process element unit Pe of the matrix (M, 1).

As described above, the memory cell array unit MC functions as an example of a storage unit that outputs logarithmic weighting coefficients corresponding to pieces of parallel logarithmic input data, which are input in parallel, to the first electronic circuit units bit by bit.

As illustrated in FIG. 5, in the phase 1, in the process element column PC₁, the process element unit Pe of the matrix (1, 1) calculates a multiplication result i₁×w₁ by the logarithmic sum and linearization, the process element unit Pe of the matrix (2, 1) calculates a multiplication result i₂×w₂ by the logarithmic sum, and the process element unit Pe of the matrix (M, 1) calculates a multiplication result i_{M}×w_{M} by the logarithmic sum.

Then, in the phase 2, the process element column PC₁ transfers the multiplication result i_{1×w1}, multiplication result i_{2×w2}, . . . , and multiplication result i_{M×wM}, which are output from the process element units Pe of the matrices (1, 1), (2, 1), . . . , and (M, 1), to the addition activation unit Act in order from the multiplication result i_{M×wM}.

Then, for the logarithmic output data of the output data O1, the addition activation unit Act generates logarithmic output data of a partial sum i_{1×w1}+i_{2×w2+} . . . +i_{M×wM}, which is a sum of M in the total sum of A×M.

In the process element column PC₂, in the phase 1, the process element unit Pe of the matrix (1, 2) calculates a multiplication result regarding the input data i₁ by the logarithmic sum and linearization, the process element unit Pe of the matrix (2, 2) calculates a multiplication result regarding the input data i₂ by the logarithmic sum and linearization, and the process element unit Pe of the matrix (M, 2) calculates a multiplication result regarding the input data i_{M} by the logarithmic sum and linearization.

Then, in the phase 2, the process element column PC₂ transfers the multiplication results, which are output from the process element units Pe of the matrices (1, 2), (2, 2), . . . , and (M, 2), to the addition activation unit Act in order from the multiplication result regarding the input data i_{M}.

Then, for the logarithmic output data of the output data O₂, the addition activation unit Act generates a partial sum that is a sum of M.

Similarly in the process element column PC_{N}, the multiplication result is calculated by the logarithmic sum and linearization.

At the timing of inputting the next input data, in the phase 1, in the process element column PC₁, the process element unit Pe of the matrix (1, 1) calculates the multiplication result i_{M+1}×w_{M+1} by the logarithmic sum and linearization, the process element unit Pe of the matrix (2, 1) calculates the multiplication result i_{M+2}×w_{M+2} by the logarithmic sum and linearization, and the process element unit Pe of the matrix (M, 1) calculates the multiplication result i_{2M}×w_{2M} by the logarithmic sum and linearization.

Then, in the phase 2, the process element column PC₁ transfers the multiplication result i_{M+1}×w_{M+1}, multiplication result i_{M+2}×w_{M+2}, . . . , and multiplication result i_{2M}×w_{2M}, which are output from the process element units Pe of the matrices (1, 1), (2, 1), . . . , and (M, 1), to the addition activation unit Act in order from the multiplication result i_{2M×w2M}.

Then, for the output data O1, the addition activation unit Act generates a partial sum i_{M+1×w1}+i_{M+2}×w_{M+2}+ . . . +i_{2M×w2M}.

The above is repeated up to the (A×M)-th input data i_{AM}, and each addition activation unit Act calculates a total sum of partial sums, applies the activation function, calculates output data o₁, . . . o_{N}, and outputs the calculated output data to the output memory array unit MAo.

Regarding output data o_{N+1}, o_{N+2}, . . . o_{N+1} as well, as described above, the processing is performed on the input data i₁ to input data i_{AM}, and each addition activation unit Act adds the value of the bias bias to the total sum of A partial sums, logarithmizes the result, applies the activation function to calculate logarithmic output data in which the output data o_{N+1}, o_{N+2}, . . . o_{N+1} as four-bit values is logarithmized, and outputs the logarithmic output data to the output memory array unit MAo.

The neural electronic circuit NN performs a similar calculation up to the output data o_{BN}. For A×M pieces of input data, M parallel inputs form a serial input of X×A×B cycle unit, and for X×B×N pieces of output data, B outputs are performed by N parallel outputs.

As described above, the memory cell array unit MC functions as an example of a storage unit that outputs the weighting coefficient corresponding to the remaining logarithmic input data when the input parallel number of pieces of logarithmic input data is larger than the inputtable parallel number by which the logarithmic input data can be input at a time in parallel. The process element unit Pe functions as an example of the first electronic circuit unit that receives the logarithmic input data in parallel by the inputtable parallel number and then receives the remaining logarithmic input data that could not be received in parallel by the inputtable parallel number.

(3.3 Connection Between Core Electronic Circuits)

Next, an example in which a neural network with intralayer expansion in the neuron layer and a neural network for increasing the number of layers are realized by connecting the core electronic circuits Core to each other will be described with reference to the diagrams.

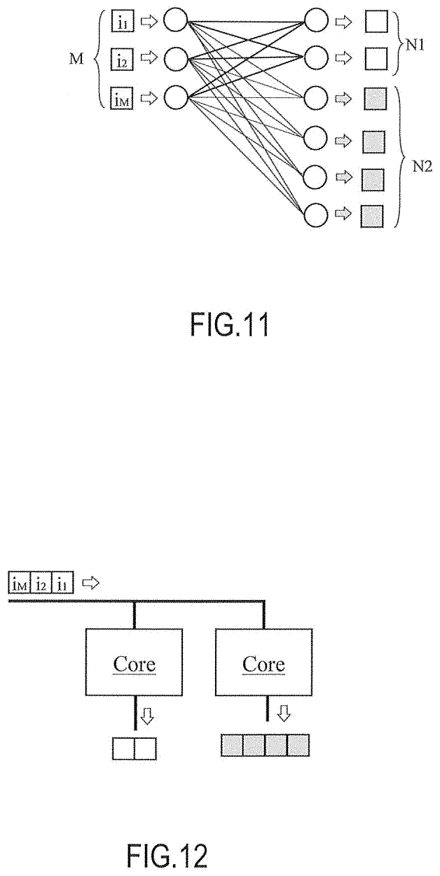

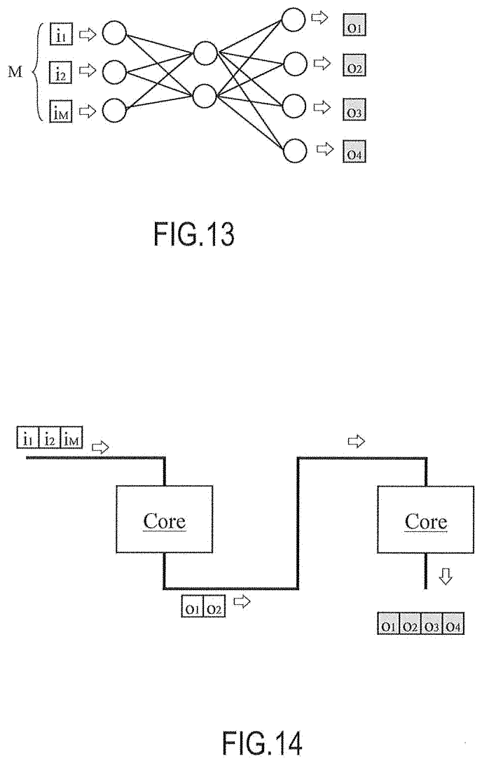

FIG. 11 is a schematic diagram illustrating an example of intralayer expansion of a neural network. FIG. 12 is a block diagram illustrating an example of a connection between core electronic circuits for realizing the intralayer expansion in FIG. 11. FIG. 13 is a schematic diagram illustrating an example of increasing the number of layers of the neural network. FIG. 14 is a block diagram illustrating an example of a connection between core electronic circuits for realizing the increase in the number of layers in FIG. 13.

For the intralayer expansion on the output side as illustrated in FIG. 11, the core electronic circuits Core may be connected in parallel to the input data as illustrated in FIG. 12.

As illustrated in FIG. 11, a two-layer neural network having three inputs and two outputs and a two-layer neural network having three inputs and four outputs may be connected in parallel, or a two-layer neural network having three inputs and three outputs and a two-layer neural network having three inputs and three outputs may be connected in parallel.

In order to increase the number of layers as illustrated in FIG. 13, the core electronic circuits Core may be connected in series as illustrated in FIG. 14.

As illustrated in FIG. 13, a two-layer neural network having three inputs and two outputs and a two-layer neural network having two inputs and four outputs are connected in series.

Actual connections are made by the system bus bus through the memory access control unit MCnt. In addition, the memory access control unit MCnt sets the input memory array unit MAi and the memory cell array unit MC to realize parallel connection or series connection between the core electronic circuits Core.

As described above, according to the present embodiment, since the multiplication result of the input data and the weighting coefficient is calculated by performing logarithmic addition by adding the logarithmic input data and the logarithmic weighting coefficient and performing linearization by inverse transformation, the multiplication can be realized by the addition circuit. Therefore, even though the value is a bit, the electronic circuit scale can be reduced, the logarithmic output data can be used as the input of the next layer by making the output be the logarithmic output data, and it is possible to realize a neural network that can handle multi-bit data while reducing the electronic circuit scale. In addition, since the multi-bit data can be handled, the recognition accuracy becomes high.

When the addition activation unit Act outputs logarithmic output data by applying the activation function to the logarithmic addition result obtained by logarithmizing the addition result, various types of activation function applications can be realized by a small-scale circuit.

In addition, when the process element unit Pe calculates the approximate multiplication result by linearizing the logarithmic addition result by the approximate expression and the addition activation unit Act adds the approximate multiplication result by the approximate expression to output logarithmic output data, logarithmic transformation can be realized with an approximate expression, so that the logarithmic transformation can be realized by a smaller circuit.

When the memory cell array unit MC stores a logarithmic weighting coefficient according to each of parallel pieces of logarithmic input data that are input in parallel, the process element unit Pe is set for each of parallel pieces of logarithmic input data, and the addition activation unit Act adds the respective multiplication results of the parallel pieces of logarithmic input data from the memory cell array units MC, since the multiplication function is realized by the logarithmic sum, the circuit scale can be reduced, and various types of neural networks can be realized by the process element unit Pe that is set according to each of parallel pieces of input data that are input in parallel.

In addition, both calculations of the convolution operation and the full-connection operation can be made efficient by the process element unit Pe having an array structure in which the inputs of neurons are shared in the row direction independently of the synapse.

In addition, when the memory cell array unit MC and the addition activation unit Act are set according to each of parallel pieces of output data that are output in parallel, a diversity of neural electronic circuits, such as a convolution type or full connection, can be easily realized.

When the flip-flop Fp for temporarily storing the multiplication result from each process element units Pe is provided, the respective flip-flops Fp are set in series, and the multiplication results are sequentially transferred to the addition activation unit Act, the wiring becomes simpler. Therefore, since the circuit area is reduced, the circuit scale can be reduced. In addition, since the wiring is simple, the manufacturing cost is reduced.

In addition, the use rate of the flip-flop Fp, which is an operator, can be maximized by controlling the midway calculation result of partial addition or the like to be transmitted in the column direction in the process element column.

When the memory cell array unit MC sequentially outputs the logarithmic weighting coefficients corresponding to the logarithmic input data, which is sequentially input to the process element unit Pe, to the process element unit bit by bit, the logarithmic value of one function of the convolution operation is set as a logarithmic weighting coefficient of the memory cell array unit MC corresponding to the filter image and the logarithmic value of the other function of the convolution operation is set as logarithmic input data corresponding to the input image, so that a highly accurate convolution neural electronic circuit can be realized.

When the process element unit Pe outputs a partial addition result obtained by adding up the multiplication results by the input parallel number of pieces of logarithmic input data that are input in parallel and the addition activation unit Act calculates an addition result from the partial addition result, it is possible to realize the multi-channel convolution operation of multiple bits with high accuracy, and it is possible to respond to input data, such as a color image.

When the memory cell array unit MC outputs the logarithmic weighting coefficient corresponding to each of parallel pieces of logarithmic input data, which are input in parallel, to each process element unit Pe, a fully connected neural electronic circuit can be realized.

When the input parallel number of pieces of logarithmic input data is larger than an inputtable parallel number by which the pieces of logarithmic input data are inputtable at a time in parallel, the first electronic circuit unit receives the logarithmic input data in parallel by the inputtable parallel number and then receives the remaining logarithmic input data that could not be received in parallel by the inputtable parallel number, and the storage unit outputs the logarithmic weighting coefficient corresponding to the remaining logarithmic input data. In this case, a multi-bit neural electronic circuit having a larger number of parallel inputs can be realized with a small number of electronic circuits.

By controlling the core electronic circuit Core in which the process element unit Pe is stored by the control unit Cnt or the memory access control unit MCnt, it is possible to calculate a network of any size. In addition, by controlling the input/output of the core electronic circuit Core by the control unit Cnt or the memory access control unit MCnt, expansion into a plurality of core electronic circuits Core is possible.

### [4. Detailed Configurations and Functions of Memory Cell, Memory Cell Block, and the Like]

Next, detailed configurations and functions relevant to the memory cell 10, a memory cell corresponding to a memory cell for connection presence/absence information, the memory cell block 15 relevant to the memory cell block CB, the memory cell array unit MC, the process element unit Pe, the addition activation unit Act, and the like will be described with reference to the diagrams.

In addition, the process element unit Pe is relevant to a majority determination input circuit 12, and the addition activation unit Act is relevant to a serial majority determination circuit 13 illustrated below. A neural network circuit and a neural network integrated circuit illustrated below are relevant to the neural electronic circuit NN.

(I) Embodiments of Memory Cell and the Like

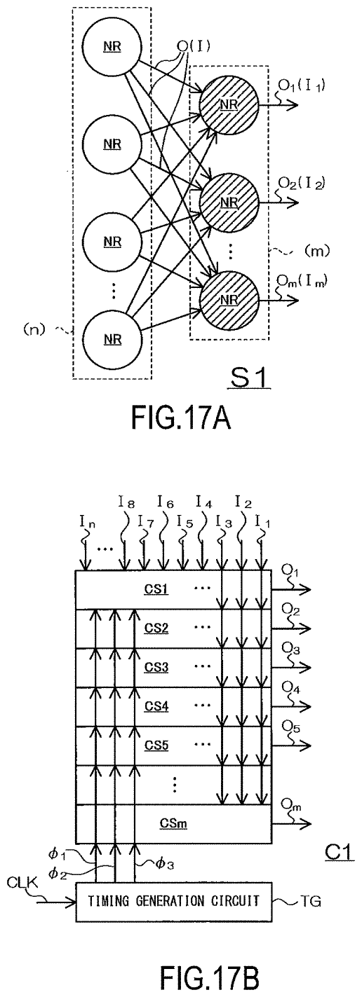

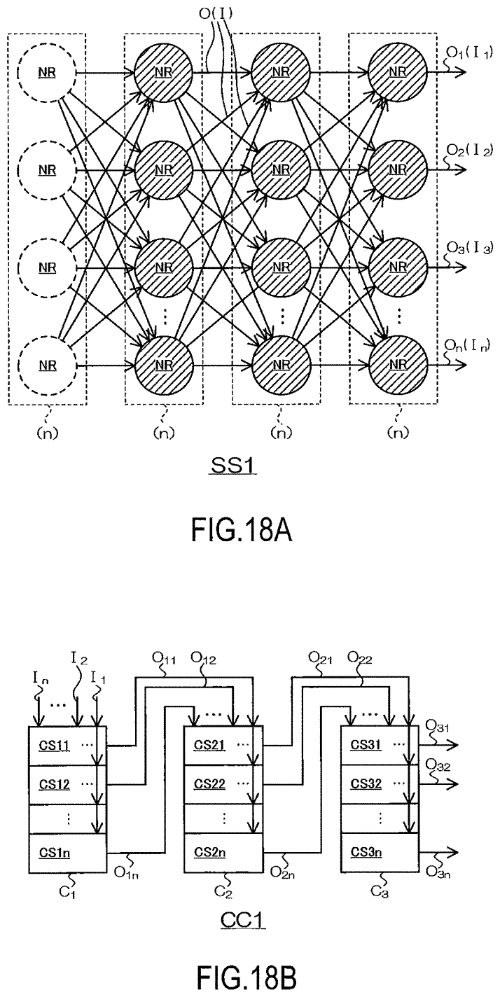

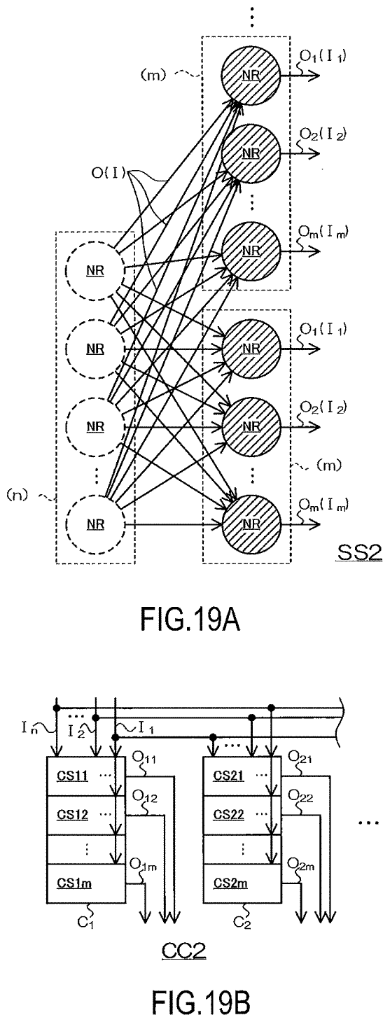

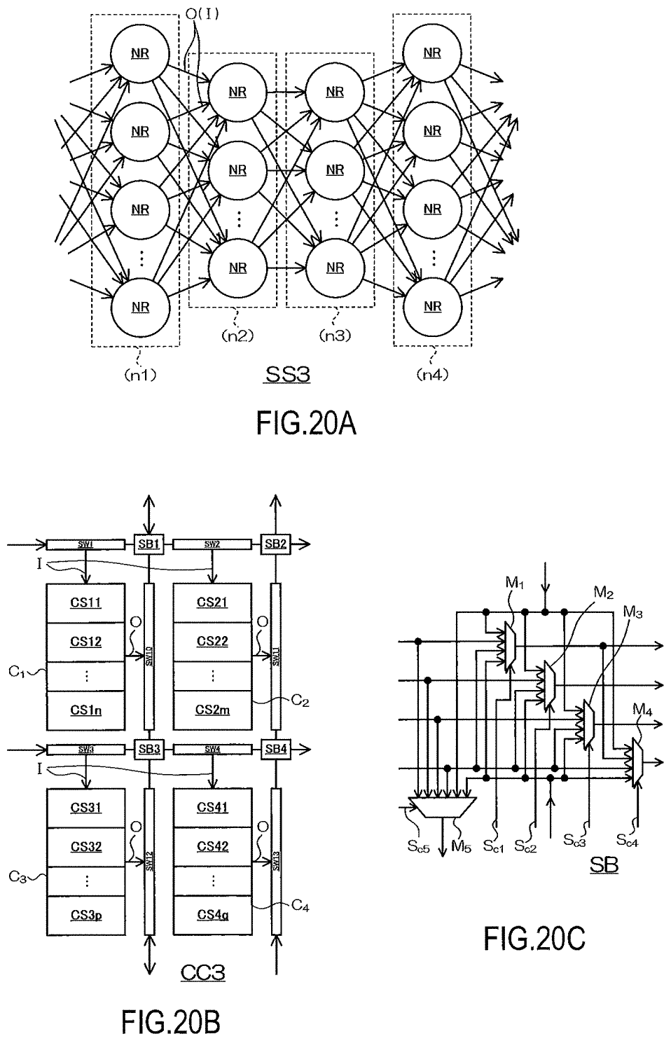

Embodiments of a memory cell and the like will be described with reference to FIGS. 15 to 20. In addition, FIGS. 15A, 15B and 15C are diagrams illustrating a neural network circuit according to the embodiment, and FIGS. 16A and 16B are diagrams illustrating a detailed configuration of the neural network circuit. In addition, FIGS. 17A and 17B are diagrams illustrating a first example of a neural network integrated circuit according to the embodiment, FIGS. 18A and 18B are diagrams illustrating a second example of the neural network integrated circuit, FIGS. 19A and 19B are diagrams illustrating a third example of the neural network integrated circuit, and FIGS. 20A, 20B and 20C are diagrams illustrating a fourth example of the neural network integrated circuit.

In addition, the neural network circuit or the neural network integrated circuit according to the embodiment and the like described below is obtained by modeling the general neural network described with reference to FIG. 1 with a neural network circuit or a neural network integrated circuit binarized by the method described in the above Non Patent Document 1 or Non Patent Document 2.

(A) Neural Network Circuit According to Embodiment

Next, the neural network circuit according to the embodiment will be described with reference to FIGS. 15 and 16. Here, in the case of describing matters common to the input data I₁ to input data Iₙ or input data Iₘ, these are simply referred to as “input data I”. In the case of describing matters common to the output data O₁ to the output data Oₙ or the output data Oₘ, these are simply referred to as “output data O”. In the case of describing matters common to the weighting coefficient W₁ to the weighting coefficient Wₙ or the weighting coefficient Wₘ, these are simply referred to as “weighting coefficient W”.

As illustrated in FIG. 15A, in a neural network S corresponding to the neural network circuit, for example, one-bit input data I is input from four other neurons NR to one neuron NR, and the output data O corresponding thereto is output from the neuron NR. At this time, the input data I is the one-bit output data O when viewed from the neuron NR as an output source. In addition, the one-bit output data O is the one-bit input data I when viewed from the neuron NR as an output destination. Since the input data I and the output data O each have one bit as described above, both the value of the input data I and the value of the output data O are either “0” or “1”. Then, the above Equation (1) corresponding to the above multiplication processing and the like performed in the neuron NR (indicated by hatching in FIG. 15A) to which the four pieces of input data I are input in FIG. 15A is an equation when n=4 in the above Equation (1). That is, the neural network S is a parallel multi-input and one output type one-stage neural network.

Next, the configuration of the neural network circuit according to the embodiment corresponding to the neuron NR indicated by hatching in the neural network S illustrated in FIG. 15A is illustrated as a neural network circuit CS in FIG. 15B. The neural network circuit CS is configured to include four memory cells 1 corresponding to the one-bit input data I₁ to one-bit input data I₄ and a majority determination circuit 2. At this time, the respective memory cells 1 correspond to an example of a “first circuit unit”, an example of a “storage unit”, and an example of an “output unit” according to the present invention. In addition, the majority determination circuit 2 corresponds to an example of a “second circuit unit” according to the present invention. In this configuration, each memory cell 1 is a ternary memory cell that stores, as a storage value, any one of three predetermined values that mean “1”, “0”, or “NC”, and has a comparison function. Then, the respective memory cells 1 output, to the majority determination circuit 2, output data E₁ to output data E₄ having values corresponding to the values of the input data I input thereto and the storage values thereof.

Here, the “NC”, which means the predetermined value that is one of the storage values of the memory cell 1, is a state in which there is no connection between the two neurons NR in the neural network S according to the embodiment. That is, when the two neurons NR (that is, an input neuron and an output neuron) to which the memory cells 1 correspond are not connected to each other, the storage value of each of the memory cell 1 is set to the above predetermined value. On the other hand, which of the other storage values (“1” or “0”) of the memory cell 1 is to be stored in the memory cell 1 is set based on the weighting coefficient W in the connection between the two neurons NR connected to each other by the connection to which the memory cell 1 corresponds. Here, which storage value is to be stored in each memory cell 1 is set in advance based on which brain function is to be modeled as the neural network S (more specifically, for example, a connection state between the neurons NR forming the neural network S) or the like. In addition, in the following description, in the case of describing matters common to the output data E₁ to the output data Eₙ, these are simply referred to as “output data E”.

In addition, the relationship between the storage value in each memory cell 1 and the value of the input data I input thereto and the value of the output data E output from each memory cell 1 is a relationship of a truth table illustrated in FIG. 15C. That is, each memory cell 1 outputs an exclusive NOR of the storage value of each memory cell 1 and the value of the input data I as the output data E from each memory cell 1. In addition, when the storage value of each memory cell 1 is the above-described predetermined value, the predetermined value is output from the memory cell 1 to the majority determination circuit 2 as the output data E regardless of the value of the input data I. In addition, the detailed configuration of each memory cell 1 will be described later with reference to FIG. 16A.

Then, based on the value of the output data E from each memory cell 1, the majority determination circuit 2 outputs the output data O of the value “1” only when the number of pieces of output data E having a value “1” is larger than the number of pieces of output data E having a value “0”, and outputs the output data O of the value “0” in other cases. At this time, a case other than a case where the number of pieces of output data E having a value “1” is larger than the number of pieces of output data E having a value “0” is, specifically, either a case where the value “NC” is output from one of the memory cells 1 or a case where the number of pieces of output data E of the value “1” from each memory cell 1 is equal to or less than the number of pieces of output data E of the value “0”. In addition, the detailed configuration of the neural network circuit CS including the majority determination circuit 2 and each memory cell 1 will be described later with reference to FIG. 16B.

Here, as described above, the neural network circuit CS is a circuit obtained by modeling the above multiplication processing, addition processing, and activation processing in the neuron NR indicated by hatching in FIG. 15A. Then, the output of the output data E as the above-described exclusive NOR from each memory cell 1 corresponds to the above-described multiplication processing using the above-described weighting coefficient W. In addition, as a premise of comparison processing for comparing the number of pieces of output data E having a value “1” and the number of pieces of output data E having a value “0”, the majority determination circuit 2 adds the number of pieces of output data E having a value “1” to calculate the total value and adds the number of pieces of output data E having a value “0” to calculate the total value. These additions correspond to the above-described addition processing. Then, the majority determination circuit 2 compares the total value of the number of pieces of output data E having a value “1” with the total value of the number of pieces of output data E having a value “0”, and the output data O having a value “1” is output from the majority determination circuit 2 only when a value obtained by subtracting the latter number from the former number is equal to or greater than a predetermined majority determination threshold value. On the other hand, in other cases, that is, when the value obtained by subtracting the total value of the number of pieces of output data E having a value “0” from the total value of the number of pieces of output data E having a value “1” is less than the majority determination threshold value, the output data O having a value “0” is output from the majority determination circuit 2. At this time, when the output data E is the predetermined value described above, the majority determination circuit 2 does not add the output data E to the number of pieces of output data E having a value “1” and the number of pieces of output data E having a value “0”.

Here, the process using the majority determination threshold value in the majority determination circuit 2 will be described more specifically. In addition, in the neural network circuit CS illustrated in FIG. 15, the total number of the number of pieces of output data E having a value “1” and the number of pieces of output data E having a value “0” is “4”. However, for clarity of description, the above processing when the total number is “10” will be described.

That is, for example, assuming that the majority determination threshold value is “0” and the number of pieces of output data E having a value “1” and the number of pieces of output data E having a value “0” are both “5”, the value obtained by subtracting the number of pieces of output data E having a value “0” from the number of pieces of output data E having a value “1” is “0”, which is equal to the majority determination threshold value. Therefore, in this case, the majority determination circuit 2 outputs the output data O having a value “1”. On the other hand, assuming that the majority determination threshold value is “0”, the number of pieces of output data E having a value “1” is “4”, and the number of pieces of output data E having a value “0” is “6”, the value obtained by subtracting the number of pieces of output data E having a value “0” from the number of pieces of output data E having a value “1” is “−2”, which is smaller than the majority determination threshold value. Therefore, in this case, the majority determination circuit 2 outputs the output data O having a value “0”.

On the other hand, for example, assuming that the majority determination threshold value is “−2” and the number of pieces of output data E having a value “1” and the number of pieces of output data E having a value “0” are both “5”, the value “0” obtained by subtracting the number of pieces of output data E having a value “0” from the number of pieces of output data E having a value “1” is larger than the majority determination threshold value. Therefore, in this case, the majority determination circuit 2 outputs the output data O having a value “1”. On the other hand, assuming that the majority determination threshold value is “−2”, the number of pieces of output data E having a value “1” is “4”, and the number of pieces of output data E having a value “0” is “6”, the value “−2” obtained by subtracting the number of pieces of output data E having a value “0” from the number of pieces of output data E having a value “1” is equal to the majority determination threshold value. Therefore, also in this case, the majority determination circuit 2 outputs the output data O having a value “1”.

The processing in the majority determination circuit 2 specifically described above corresponds to the activation processing. As described above, by the neural network circuit CS illustrated in FIG. 15B, each process as the neuron NR indicated by hatching in FIG. 15A is modeled.

Next, the detailed configuration of each memory cell 1 will be described with reference to FIG. 16A. As illustrated in FIG. 16A, each memory cell 1 is configured to include transistors T₁ to T₁₄ and inverters IV₁ to IV₄. In addition, each of the transistors T₁ and the like illustrated in FIG. 16 is, for example, a Metal Oxide Semiconductor Field Effected Transistor (MOSFET). In addition, these elements are connected to each other in a form illustrated in FIG. 16A by a connection line LIₙ and a connection line /LIₙ corresponding to the input data Iₙ, connection lines W1 and W2 corresponding to the Word signal, and a match line M and an inverted match line /M corresponding to the match signal, thereby forming one memory cell 1. At this time, one memory CL₁ as, for example, a static random access memory (SRAM) is formed by the transistors T₁ and T₂ and the inverters IV₁ and IV₂, and one memory CL₂ as, for example, an SRAM is formed by the transistors T₃ and T₄ and the inverters IV₃ and IV₄. In addition, the transistors T₅ to T₉ form an XNOR gate G1, and the transistors T₁₀ to T₁₄ form an XOR gate G₂.

Next, the detailed configuration of the neural network circuit CS including the majority determination circuit 2 and each memory cell 1 will be described with reference to FIG. 16B. In addition, FIG. 16B shows the detailed configuration of the neural network circuit CS having four pieces of input data I (that is, four memory cells 1 are provided) corresponding to FIG. 15A. In addition, in the neural network circuit CS illustrated in FIG. 16B, a case where the majority determination threshold value is “0” will be described.

As illustrated in FIG. 16B, the neural network circuit CS is configured to include four memory cells 1 and transistors T₂₀ to T₃₀ (refer to broken lines in FIG. 16B) forming the majority determination circuit 2. At this time, as shown by a one-dot chain line in FIG. 16B, a flip-flop type sense amplifier SA is formed by transistors T₂₅ to T₂₈. In addition, these elements are connected to each other in a form illustrated in FIG. 16B by the connection lines W1 and W2, the connection lines M and /M, and connection lines LO and /LO corresponding to the output data O, all of which are common to the four memory cells 1, thereby forming one neural network circuit CS. In addition, a timing signal φ₁, a timing signal φ₂ and a timing signal /φ₂, and a timing signal φ₃ set in advance to define the processing as the neural network circuit CS are input from the outside to the neural network circuit CS illustrated in FIG. 16B. At this time, the timing signal φ₁ is input to the gate terminals of the transistors T₂₀ to T₂₂, the timing signal φ₂ and the timing signal /φ₂ are input to the gate terminals of the transistors T₂₉ and T₃₀, and the timing signal φ₃ is input to the gate terminals of the transistors T₂₃ and T₂₄. In the configuration described above, in the match line M and the inverted match line /M of each memory cell 1 precharged based on the timing signal φ₁, the timing at which the precharged charges are extracted differs depending on the value of the input data I and the storage values of the memory CL₁ and the memory CL₂. Then, the sense amplifier SA detects which of the match line M or the inverted match line /M extracts the precharged charges more quickly, amplifies a voltage difference between the match line M and the inverted match line /M, and outputs the detection result to the connection lines LO and /LO. Here, the value of “1” on the connection line LO means that the value of the output data O as the neural network circuit CS is “1”. With the above-described configuration and operation, the neural network circuit CS performs processing for modeling each process as the neuron NR, which is indicated by hatching in FIG. 15A, based on the timing signal φ₁ and the like, and outputs the output data O.

(B) Regarding First Example of Neural Network Integrated Circuit According to Embodiment

Next, a first example of the neural network integrated circuit according to the embodiment will be described with reference to FIG. 17. In addition, in FIG. 17, the same components as those of the neural network circuit according to the embodiment described with reference to FIGS. 15 and 16 are denoted by the same reference numerals, and detailed description thereof will be omitted.

Neural network integrated circuits according to the embodiment described below with reference to FIGS. 17 to 20 are integrated circuits in which a plurality of neural network circuits according to the embodiment described with reference to FIGS. 15 and 16 are integrated. In addition, these neural network integrated circuits are for modeling a complicated neural network including a larger number of neurons NR.

First, a first example of the neural network integrated circuit according to the embodiment for modeling a neural network S1 illustrated in FIG. 17A will be described. The neural network S1 is a neural network in which one-bit output data O is output from the neuron NR indicated by hatching by outputting one-bit output data O from n neurons NR to m neurons NR indicated by hatching in FIG. 17A. That is, the neural network S1 is a parallel multi-input and parallel multi-output type one-stage neural network. Here, in FIG. 17A, a case where all of the neurons NR are connected to each other by the input signal I or the output signal O is illustrated. However, according to the brain function to be modeled, any of the neurons NR may not be connected. In addition, this is expressed in a manner that the above-described predetermined value is stored as a storage value of the memory cell 1 corresponding to the connection between the neurons NR that are not connected to each other. In addition, this point is also the same in the case of a neural network described below with reference to FIG. 18A, FIG. 19A, or FIG. 20A.

When modeling the neural network S1 described above, the number of pieces of one-bit input data I is n in the neural network circuit CS according to the embodiment described with reference to FIGS. 15 and 16. At this time, each of the neural network circuits CS to which the n pieces of input data I are input is a model of the function of the neuron NR indicated by hatching in FIG. 17A, and performs the above-described multiplication processing, addition processing, and activation processing. In addition, in the following description using FIGS. 17 to 20, the neural network circuits CS to which the n pieces of input data I are input are referred to as a “neural network circuit CS1”, a “neural network circuit CS2”, . . . . In addition, as the first example of the neural network integrated circuit according to the embodiment, m neural network circuits CS1 to which the n pieces of input data I are input and the like are integrated.

That is, as illustrated in FIG. 17B, a neural network integrated circuit C1 that is the first example of the neural network integrated circuit according to the embodiment is formed by integrating m neural network circuits CS1 to CSm to which n pieces of one-bit input data I₁ to one-bit input data Iₙ are commonly input. Then, the above-described timing signal φ₁ and the like are commonly input from a timing generation circuit TG to each of the neural network circuits CS1 to CSm. At this time, the timing generation circuit TG generates the timing signal φ₁ and the like based on a reference clock signal CLK set in advance and outputs the timing signal φ₁ and the like to the neural network circuits CS1 to CSm. Then, the neural network circuits CS1 to CSm output one-bit output data O₁, one-bit output data O₂, . . . , and one-bit output data Oₘ based on the input data I₁ to input data Iₙ, the timing signal φ₁, and the like.

In the neural network integrated circuit C1 having the above-described configuration, the output data O is output from the n neurons NR to the m neurons NR, so that the neural network S1 in FIG. 17A is modeled in which a total of m pieces of output data O are output from the m neurons NR.

(C) Regarding Second Example of Neural Network Integrated Circuit According to Embodiment

Next, a second example of the neural network integrated circuit according to the embodiment will be described with reference to FIG. 18. In addition, in FIG. 18, the same components as those of the neural network circuit according to the embodiment described with reference to FIGS. 15 and 16 are denoted by the same reference numerals, and detailed description thereof will be omitted.

The second example of the neural network integrated circuit according to the embodiment is a neural network integrated circuit for modeling a neural network SS1 illustrated in FIG. 18A. The neural network SS1 corresponds to a case where n=m in the neural network S1 described with reference to FIG. 17A. That is, the neural network SS1 is a neural network in which the output data O is output from n neurons NR in the rightmost column in FIG. 18A by outputting the output data O from (n) neurons NR in adjacent columns to 3×n neurons NR indicated by hatching in FIG. 18A. The neural network SS1 is a parallel multi-input and parallel multi-output type multi-stage neural network.

When modeling the neural network SS1 as well, as in the neural network S1 described with reference to FIG. 17, the number of pieces of one-bit input data I is n in the neural network circuit CS according to the embodiment described with reference to FIGS. 15 and 16. At this time, each of the neural network circuits CS to which the n pieces of input data I are input is a model of the function of the neuron NR indicated by hatching in FIG. 18A, and performs the above-described multiplication processing, addition processing, and activation processing. In addition, as the second example of the neural network integrated circuit according to the embodiment, neural network circuits CS11 and the like to which the n pieces of input data I are input are connected in series for integration of 3×n in total.

That is, as illustrated in FIG. 18B, in a neural network integrated circuit CC1 that is the second example of the neural network integrated circuit according to the embodiment, n neural network circuits CS11 to CS1n to which n pieces of one-bit input data I₁ to one-bit input data Iₙ are commonly input are integrated to form one neural network integrated circuit C1 (refer to FIG. 17B). Then, the neural network circuits CS11 to CS1n forming the neural network integrated circuit C1 output one-bit output data O₁₁ to one-bit output data O₁ₙ, respectively, and these are commonly input to n neural network circuits CS21 to CS2n in the next stage. These neural network circuits CS21 to CS2n form another neural network integrated circuit C2. Then, the neural network circuits CS21 to CS2n forming the neural network integrated circuit C2 output one-bit output data O₂₁ to one-bit output data O₂ₙ, respectively, and these are commonly input to n neural network circuits CS31 to CS3n in the next stage. These neural network circuits CS31 to CS3n further form one neural network integrated circuit C3. Here, the timing signals φ₁ and the like are commonly input to the neural network circuits CS11 and the like as in the case illustrated in FIG. 17A. However, for simplification of description, these are not illustrated in FIG. 18B. Then, the neural network integrated circuit C1 generates output data O₁₁, output data O₁₂, . . . , and output data O₁ₙ based on the input data I₁ to input data Iₙ, the timing signal φ₁, and the like, and commonly outputs these to the neural network integrated circuit C2 in the next stage. Then, the neural network integrated circuit C2 generates output data O₂₁, output data O₂₂, . . . , and output data O₂ₙ based on the output data O₁₂ to output data O₁ₙ, the timing signal φ₁, and the like, and commonly outputs these to the neural network integrated circuit C3 in the next stage. Finally, the neural network integrated circuit C3 generates and outputs final output data O₃₁, output data O₃₂, . . . , and output data O₃ₙ based on the output data O₂₁ to output data O₂ₙ, the timing signal φ₁, and the like.

In the neural network integrated circuit CC1 having the above-described configuration, the output of one-bit output data O from n neurons NR to n neurons NR in the next stage is repeated stepwise, so that the neural network SS1 in FIG. 18A is modeled in which a total of n pieces of output data O are finally output.

(D) Regarding Third Example of Neural Network Integrated Circuit According to Embodiment

Next, a third example of the neural network integrated circuit according to the embodiment will be described with reference to FIG. 19. In addition, in FIG. 19, the same components as those of the neural network circuit according to the embodiment described with reference to FIGS. 15 and 16 are denoted by the same reference numerals, and detailed description thereof will be omitted.

The third example of the neural network integrated circuit according to the embodiment is an example of a neural network integrated circuit for modeling a neural network SS2 illustrated in FIG. 19A. The neural network SS2 is a neural network which includes a plurality of sets each including m neurons NR indicated by hatching in FIG. 19A and in which a total of m×(the number of sets) pieces of output data O are output in one bit from each neuron NR indicated by hatching in FIG. 19A by outputting one-bit output data O from each of n common neurons NR (shown by broken lines in FIG. 19A) to each of these neurons NR. In the case of the neural network SS2, each neuron NR indicated by hatching in FIG. 19A receives the same number (n pieces) of output data O in one bit. That is, the neural network SS2 is a parallel multi-input and parallel multi-output type one-stage neural network.

When modeling the neural network SS2 as well, as in the neural network S1 described with reference to FIG. 17, the number of pieces of one-bit input data I is n in the neural network circuit CS according to the embodiment described with reference to FIGS. 15 and 16. At this time, each of the neural network circuits CS to which the n pieces of input data I are input is a model of the function of the neuron NR indicated by hatching in FIG. 19A, and performs the above-described multiplication processing, addition processing, and activation processing. In addition, as the third example of the neural network integrated circuit according to the embodiment, the neural network circuits CS11 and the like to which the n pieces of input data I are input are connected in parallel for integration of the above number of sets.

That is, as illustrated in FIG. 19B, in a neural network integrated circuit CC2 that is the third example of the neural network integrated circuit according to the embodiment, m neural network circuits CS11 to CS1m to which n pieces of one-bit input data I₁ to one-bit input data Iₙ are commonly input are integrated to form one neural network integrated circuit C1 (refer to FIG. 17B). In addition, m neural network circuits CS21 to CS2m to which the same n pieces of input data I₁ to input data Iₙ are input in parallel and commonly are integrated to form another neural network integrated circuit C2 (refer to FIG. 17B). Thereafter, similarly, m neural network circuits to which n pieces of input data I₁ to input data Iₙ are input in parallel and commonly are integrated to form another neural network integrated circuit that is not illustrated in FIG. 19B. Here, similarly to the case described with reference to FIG. 18, the same timing signal φ₁ and the like as in the case illustrated in FIG. 17A are commonly input to each neural network circuit CS11 and the like. However, for simplification of description, these are not illustrated in FIG. 19B. Then, the neural network integrated circuit C1 generates and outputs one-bit output data O₁₁, one-bit output data O₁₂, . . . , and one-bit output data O₁ₘ based on the input data I₁ to input data Iₙ, the timing signal φ₁, and the like. On the other hand, the neural network integrated circuit C2 generates and outputs one-bit output data O₂₁, one-bit output data O₂₂, . . . , and one-bit output data O₂ₘ based on the same input data I₁ to input data Iₙ, the timing signal φ₁, and the like. Thereafter, other neural network integrated circuits (not illustrated) also output m pieces of output data.

In the neural network integrated circuit CC2 having the above-described configuration, the output data O is output in parallel from m×(the number of sets) neurons NR, so that the neural network SS2 in FIG. 19A is modeled in which a total of m×(the number of sets) pieces of output data O are finally output.

(E) Regarding Fourth Example of Neural Network Integrated Circuit According to Embodiment

Finally, a fourth example of the neural network integrated circuit according to the embodiment will be described with reference to FIG. 20. In addition, in FIG. 20, the same components as those of the neural network circuit according to the embodiment described with reference to FIGS. 15 and 16 are denoted by the same reference numerals, and detailed description thereof will be omitted.

The fourth example of the neural network integrated circuit according to the embodiment is an example of a neural network integrated circuit for modeling a neural network SS3 illustrated in FIG. 20A. The neural network SS3 is a neural network in which the degree of freedom regarding the number of neurons NR and the connection mode between the neurons NR is further improved as compared with the neural networks S1 and the like according to the above-described embodiments described so far. In addition, in FIG. 20A, the neural network SS3 is illustrated in which the number of neurons NR belonging to each neuron group (refer to broken lines in FIG. 20A), through which stepwise transmission and reception of one-bit output data O (input data I) are performed, is different.

When modeling the neural network SS3 described above, the number of pieces of one-bit input data I, for example, n in the neural network circuit CS according to the embodiment described with reference to FIGS. 2 to 16. At this time, each of the neural network circuits CS to which then pieces of input data I are input is a model of the function of each neuron NR illustrated in FIG. 20A, and performs the above-described multiplication processing, addition processing, and activation processing. In addition, as the fourth example of the neural network integrated circuit according to the embodiment, a plurality of neural network integrated circuits each including a plurality of neural network circuits CS11, to which the n pieces of input data I are input, and the like are provided, and the neural network integrated circuits are integrated by being connected to each other by a plurality of switches and a switch box for switching of the switches to be described later.

That is, as illustrated in FIG. 20B, in a neural network integrated circuit CC3 that is the fourth example of the neural network integrated circuit according to the embodiment, n neural network circuits CS11 to CS1n to which n pieces of one-bit input data I₁ to one-bit input data Iₙ are commonly input are integrated to form one neural network integrated circuit C1 (refer to FIG. 17B). Then, similarly, for example, m neural network circuits CS21 to CS2m are integrated to form one neural network integrated circuit C2, neural network circuits CS31 to CS3p (p is a natural number of 2 or more; the same hereinbelow) are integrated to form one neural network integrated circuit C3, and neural network circuits CS41 to CS4q (q is a natural number of 2 or more; the same hereinbelow) are integrated to form one neural network integrated circuit C4. In addition, as illustrated in FIG. 20B, the neural network integrated circuits C1 to C4 can transmit and receive one-bit input data I and one-bit output data O to and from each other through switches SW1 to SW4. In addition, the modes of transmission and reception of the input data I and the output data O between the neural network integrated circuits C1 to C4 (that is, connection modes between the neural network integrated circuits C1 to C4) are switched by switch boxes SB1 to SB4 through the switches SW1 to SW4. At this time, the switches SW1 to SW4 and the switch boxes SB1 to SB4 correspond to an example of a “switch unit” according to the present invention.

Next, the detailed configuration of the switch boxes SB1 to SB4 will be described with reference to FIG. 20C. In addition, since the switch boxes SB1 to SB4 have the same configuration, these will be collectively described as a switch box SB in FIG. 20C.

As illustrated in FIG. 20C, the switch box SB for controlling the connection mode of one-bit input data I or output data O in the neural network integrated circuit CC3 and consequently the number of effective neurons NR is formed by connecting selectors M₁ to M₅ to each other in a mode illustrated in FIG. 20C. In the configuration of the switch box SB illustrated in FIG. 20C, the signal corresponding to the input data I described above is a signal input from the left in FIG. 20C, and the signal corresponding to the output data O described above is a signal input from the upper and lower sides in FIG. 20C. Then, the switching of the input data I and the like with respect to the neural network integrated circuits C1 to C4 is performed by selectors M₁ to M₅ to which switching control signals S_{c1} to S_{c5} for controlling the switching are input from the outside.

As described above, the neural network SS3 in FIG. 20A that generates and outputs the output data O corresponding to the input data I is modeled by the neural network integrated circuit CC3 having the configuration illustrated in FIG. 20B, in which the switches SW1 to SW4 are switched by the switch boxes SB1 to SB4 having the configuration illustrated in FIG. 20C.

As described above, according to the configurations and operations of the neural network circuit CS, the neural network integrated circuit C1, and the like according to the embodiment, as illustrated in FIGS. 15 and 16, each of the memory cells 1 of which the number is predetermined based on the brain function to be supported stores a predetermined value meaning “NC” or “1” or “0” as a storage value, and outputs “1” corresponding to the input of the input data I when the value of the one-bit input data and the storage value are equal, outputs “0” corresponding to the input of the input data I when the value of the one-bit input data I and the storage value are not equal, and outputs the predetermined value regardless of the value of the input data I when the predetermined value is stored. Then, the majority determination circuit 2 outputs the value “1” as the output data O when the total number of memory cells 1 that output the value “1” is larger than the total number of memory cells 1 that output the value “0”, and outputs the value “0” as the output data O when the total number of memory cells 1 that output the value “1” is equal to or less than the total number of memory cells 1 that output the value “0”. Therefore, since the multiplication processing as a neural network circuit is performed in the memory cell 1 and the addition processing and the activation processing as a neural network circuit are performed by one majority determination circuit 2, neural network circuits can be efficiently realized while significantly reducing the circuit scale and corresponding cost.

In addition, as illustrated in FIG. 17B, when m neural network circuits CS each having n memory cells 1 corresponding to n pieces of one-bit input data I are provided, n pieces of input data I are input in parallel and commonly to each neural network circuit CS, and the output data O is output from each neural network circuit CS, the n×m neural network integrated circuit C1 that models the neural network S1 illustrated in FIG. 17A and has n inputs and m outputs can be efficiently realized while significantly reducing the circuit scale and the corresponding cost. In addition, in this case, even if there are various connection patterns between the m neurons NR indicated by hatching in FIG. 17A and the n neurons NR that respectively output the output data O to the m neurons, the neural network integrated circuit C1 can be realized more efficiently by using the above-described predetermined value as a storage value of the memory cell 1 corresponding to a case where there is no connection between the neurons NR in the neural network integrated circuit C1. In addition, in the case illustrated in FIG. 17, since n pieces of input data I can be input in parallel and commonly to each neural network circuit CS and m pieces of output data O based on these can be output in parallel, it is possible to significantly increase the processing speed compared with a case where the input data I and the output data O have to be sequentially input and output.

In addition, as illustrated in FIG. 18, when the neural network integrated circuits C1 and the like having the same “n” and the same “m” are connected in series and the output data O from one neural network integrated circuit C1 (or the neural network integrated circuit C2) is the input data I in another neural network integrated circuit C2 (or the neural network integrated circuit C3) connected immediately after the neural network integrated circuit C1 (or the neural network integrated circuit C2), the neural network integrated circuit CC1 having parallel inputs and parallel outputs can be efficiently realized while significantly reducing the circuit scale and the corresponding cost.

In addition, as illustrated in FIG. 19, when n pieces of input data I are input in parallel and commonly to each neural network integrated circuit CS and in pieces of output data O are output in parallel from each neural network integrated circuit CS, the neural network integrated circuit CC2 that has parallel inputs and parallel outputs and has the number of pieces of output data O larger than the number of pieces of input data I can be efficiently realized while significantly reducing the circuit scale and the corresponding cost.

In addition, as illustrated in FIG. 20, when a plurality of neural network integrated circuits C1 and the like are provided and the input data I and the output data O for each neural network integrated circuit C1 and the like are switched by the switches SW1 and the like that connect the neural network integrated circuits C1 and the like to each other in an array form, if the switching operation in the switches SW1 and the like is defined based on the brain function to be supported, the large-scale neural network integrated circuit CC3 can be efficiently realized while significantly reducing the corresponding cost.

(II) Related Form

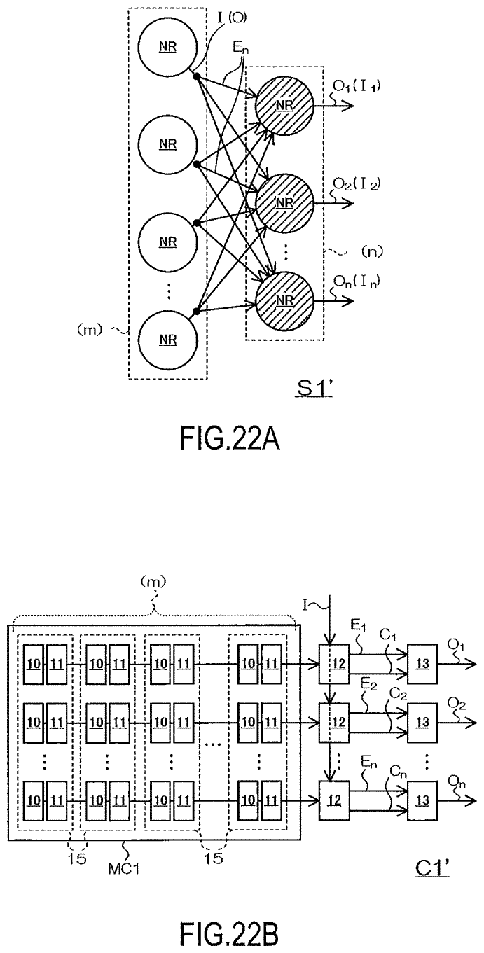

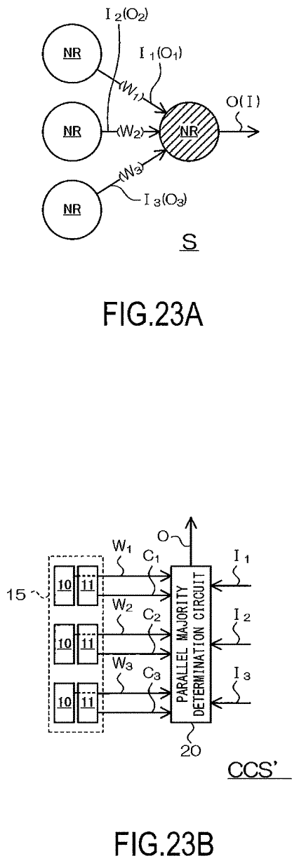

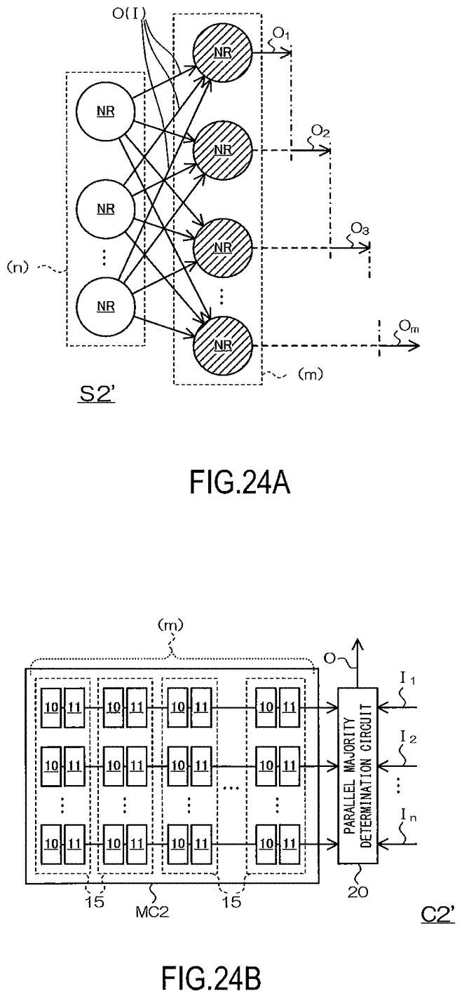

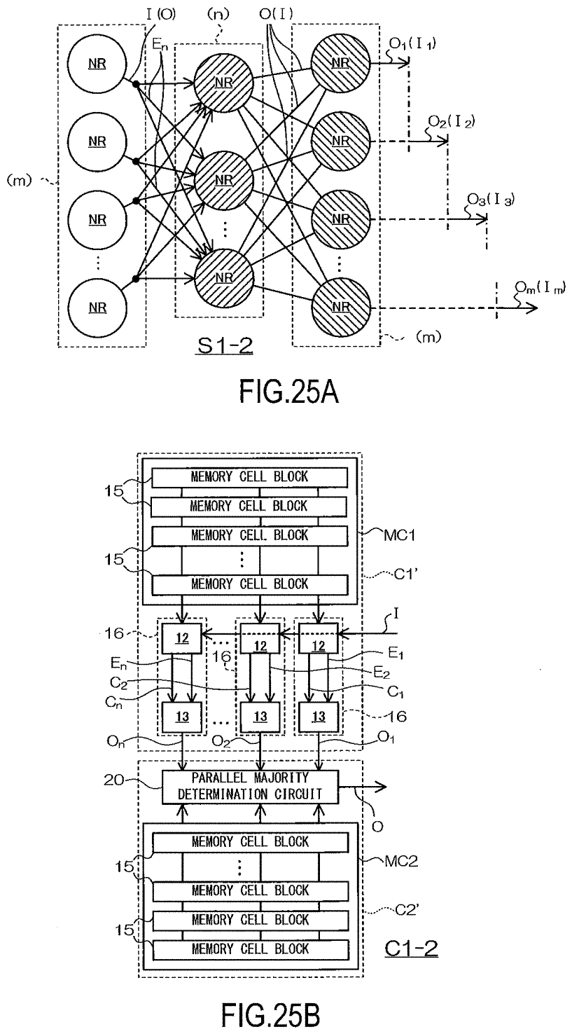

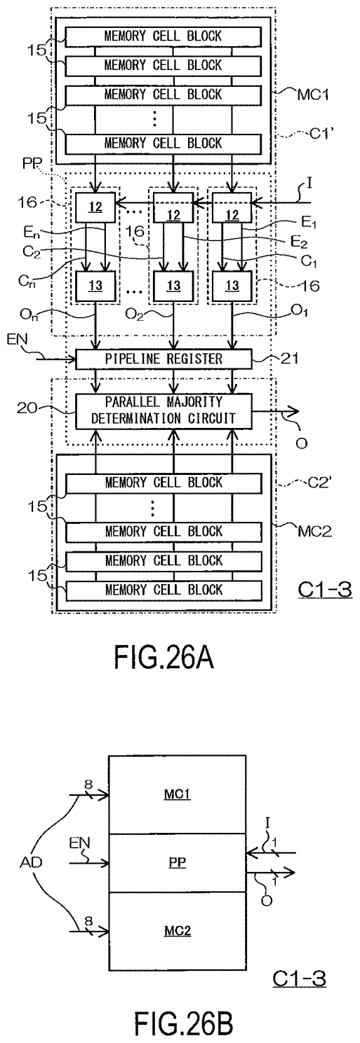

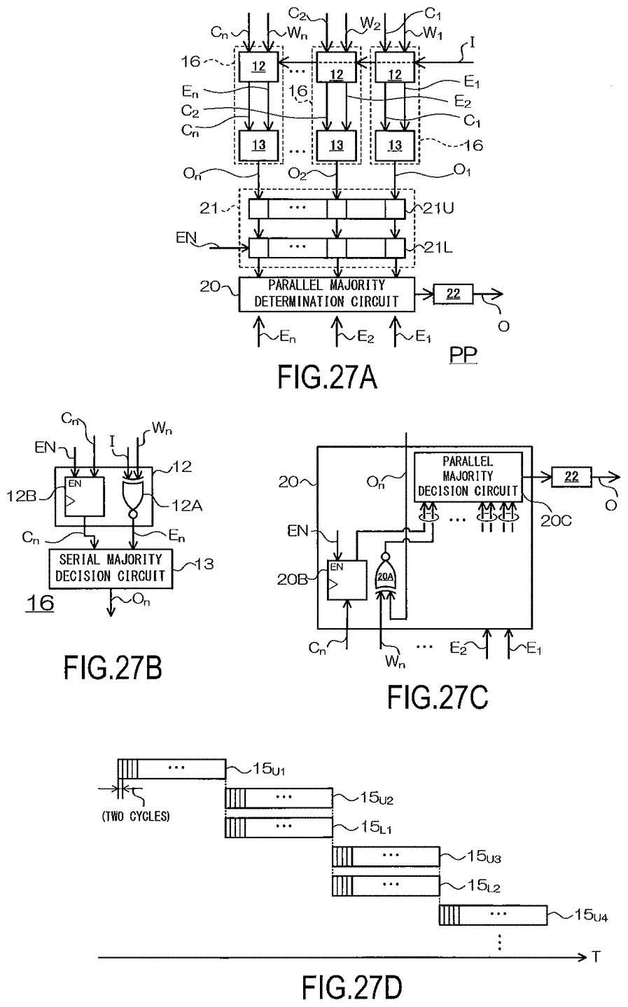

Next, a related form relevant to the present invention will be described with reference to FIGS. 21A to 27D. In addition, FIGS. 21A, 21B, 21C, 22A and 22B are diagrams illustrating a first example of a neural network integrated circuit according to the related form, FIGS. 23A and 23B are diagrams illustrating a first example of the neural network circuit according to the related form, and FIGS. 24A and 24B are diagrams illustrating a second example of the neural network integrated circuit according to the related form. In addition, FIGS. 25A and 25B are diagrams illustrating a third example of the neural network integrated circuit, FIGS. 26A and 26B are diagrams illustrating a fourth example of the neural network integrated circuit, and FIGS. 27A, 27B, 27C and 27D are diagrams illustrating a detailed configuration of the fourth example.

A related form described below is to model the neural network S or the like by a configuration or method different from the configuration or method of modeling the neural network S or the like described above with reference to FIGS. 1 and 15 to 20C.

(A) First Example of Neural Network Integrated Circuit According to Related Form

First, a first example of the neural network integrated circuit according to the related form will be described with reference to FIGS. 21A, 21B, 21C, 22A and 22B. In addition, FIGS. 21A, 21B and 21C are diagrams illustrating a part of the first example in which the multiplication processing as the first example is performed, and FIGS. 22A and 22B are diagrams illustrating the entire first example.

As illustrated in FIG. 21A, in a network S′ modeled by a part of the first example, one-bit output data O (in other words, input data I) is input from one neuron NR. Then, the input data I is multiplied by one of the different weighting coefficients W₁ to W₄ respectively corresponding to a plurality of other neurons (not illustrated) as output destinations of the input data I, and the result is output to the other neurons (not illustrated) as output data E₁ to output data E₄. In addition, the output data E at this time is a one-bit signal similarly to the input data I. Therefore, the value of the input data I, the value of each weighting coefficient W, and the value of the output data E illustrated in FIG. 21 are all “0” or “1”.

Next, the configuration of a portion corresponding to the network S′ illustrated in FIG. 21A in the first example of the neural network integrated circuit according to the related form is illustrated as a network circuit CS' in FIG. 21B. The network circuit CS' includes four sets of memory cells 10 and memory cells 11 (memory cells for connection presence/absence information) respectively corresponding to the output data E₁ to output data E₄ illustrated in FIG. 21A and four majority determination input circuits 12 corresponding to the output data E (in other words, input data I of other neurons (not illustrated)). At this time, the number of memory cell pairs of one memory cell 10 and one memory cell 11 and the number of majority determination input circuits 12 corresponding thereto (both four in the case illustrated in FIG. 21) are equal to the number of pieces of output data O desired as the first example of the neural network integrated circuit according to the related form. In addition, in the following description of FIG. 21, the above-described memory cell pairs corresponding to the number of pieces of output data O are collectively referred to as a “memory cell block 15” (refer to a broken line in FIG. 21B).

In the configuration described above, each memory cell 10 in each memory cell block 15 stores the one-bit weighting coefficient W set in advance based on the brain function that the first example of the neural network integrated circuit according to the related form including the network circuit CS' should support. On the other hand, each memory cell 11 in each memory cell block 15 stores one-bit connection presence/absence information set in advance based on the brain function. Here, the connection presence/absence information corresponds to the storage value “NC” of the memory cell 1 in the above embodiment, and is a storage value for indicating whether there is a connection between two neurons NR in the neural network according to the related form or there is no connection therebetween. In addition, which storage value is to be stored in each of the memory cells 10 and 11 may be set in advance based on, for example, which brain function is to be modeled as the first example of the neural network integrated circuit according to the related form including the network S′.

Then, the respective memory cells 10 output the storage values to the majority determination input circuit 12 as a weighting coefficient W₁, a weighting coefficient W₂, a weighting coefficient W₃, and a weighting coefficient W₄. At this time, the respective memory cells 10 output the storage values to the majority determination input circuit 12 simultaneously as the weighting coefficients W₁ to W₄. In addition, this simultaneous output configuration is the same for each memory cell 10 in the neural network circuit and the neural network integrated circuit described below with reference to FIGS. 22 to 27. On the other hand, the respective memory cells 11 also output the storage values to the majority determination input circuit 12 as connection presence/absence information C₁, connection presence/absence information C₂, connection presence/absence information C₃, and connection presence/absence information C₄. At this time, the respective memory cells 11 output the storage values to the majority determination input circuit 12 simultaneously as the connection presence/absence information C₁ to connection presence/absence information C₄. In addition, the respective memory cells 11 shift the outputs of the storage values from the memory cells 10, for example, one cycle before or after and output the storage values to the majority determination input circuit 12 simultaneously. In addition, this simultaneous output configuration and the timings and relationship of the outputs of the storage values from the respective memory cells 10 are the same for each memory cell 11 in the neural network circuit and the neural network integrated circuit described below with reference to FIGS. 22 to 27. In addition, in the case of describing matters common to the connection presence/absence information C₁, connection presence/absence information C₂, connection presence/absence information C₃, . . . , these are simply referred to as “connection presence/absence information C”.

On the other hand, one-bit input data I from another node NR (refer to FIG. 21A) not illustrated in FIG. 21B is commonly input to each majority determination input circuit 12. Then, the majority determination input circuits 12 output the connection presence/absence information, which is output from the corresponding memory cell 11, as it is as the connection presence/absence information C₁ to connection presence/absence information C₄, respectively.

In addition to these, the respective majority determination input circuits 12 calculate an exclusive OR (XNOR) between the input data I and the weighting coefficient W₁, the weighting coefficient W₂, the weighting coefficient W₃, and the weighting coefficient W₄ output from the corresponding memory cells 10, and output the results as the output data E₁, the output data E₂, the output data E₃, and the output data E₄. At this time, the relationship among the storage value (weighting coefficient W) of the corresponding memory cell 11, the value of the input data I, and the value of the output data E output from the majority determination input circuit 12 is a relationship illustrated in a truth table in FIG. 21C. In addition, FIG. 21C also describes an exclusive OR (XOR) as a premise for calculating the above-described exclusive NOR (XNOR).

Here, the truth table (refer to FIG. 15C) corresponding to the neural network circuit CS according to the embodiment described with reference to FIG. 15 is compared with the truth table illustrated in FIG. 21C. At this time, assuming that the storage value in the memory cell 10 and the value of the input data I are the same as those in the truth table illustrated in FIG. 15C, the value of the output data E illustrated in FIG. 21B is the same as the value of the output data E illustrated in FIG. 15B. As a result, the network circuit CS' illustrated in FIG. 21B is a circuit that models the multiplication processing in the network S′ illustrated in FIG. 21A by the same logic as the multiplication processing in the neural network circuit CS illustrated in FIG. 15B. That is, calculating the exclusive OR between each storage value (weighting coefficient W) output from each memory cell 10 and the value of the input data I in the majority determination input circuit 12 corresponds to the multiplication processing described above. As described above, the multiplication processing in the network S′ illustrated in FIG. 21A is modeled by the network circuit CS' illustrated in FIG. 21B.

(B) First Example of Neural Network Integrated Circuit According to Related Form

Next, a first example of the neural network integrated circuit according to the related form will be described with reference to FIGS. 21 and 22. In addition, in FIG. 22, the same components as the network circuit according to the related form described with reference to FIG. 21 are denoted by the same reference numerals, and detailed description thereof will be omitted.

The first example of the neural network integrated circuit according to the related form described with reference to FIG. 22 is an integrated circuit in which a plurality of network circuits CS' according to the related form described with reference to FIG. 21 are integrated. In the first example of the neural network integrated circuit according to the related form, the above addition processing and the above activation processing are performed in addition to the above multiplication processing corresponding to the network circuit CS′.

First, an entire neural network modeled by the first example of the neural network integrated circuit according to the related form will be described with reference to FIG. 22A. The neural network S1′ illustrated in FIG. 22A includes the network S′ described with reference to FIG. 21 corresponding to m neurons NR. In the neural network S1′, for each of the n neurons NR indicated by hatching in FIG. 22A, one-bit output data O (in other words, input data I) is output from each of the m neurons NR forming the network S′ to each of the n neurons NR indicated by hatching in FIG. 22A. Then, the output data O becomes the output data E to be input to each of the n neurons NR indicated by the hatching, and a total of n pieces of output data O output from the neurons NR indicated by the hatching are output in parallel one by one. That is, the neural network S1′ is a serial (m) input-parallel (n) output type one-stage neural network.

The first example of the neural network integrated circuit according to the related form in which the neural network S1′ is modeled is a neural network integrated circuit C1′ illustrated in FIG. 22B. The neural network integrated circuit C1′ includes m neural network circuits CS′ (refer to FIG. 21) according to the related form, each of which includes the above-described n memory cell pairs and the above-described n majority determination input circuits 12, and includes n serial majority determination circuits 13 corresponding to the majority determination input circuits 12 and the memory cell pairs. Then, as illustrated in FIG. 22B, the memory cell array MC1 is configured to include the n×m memory cell pairs (in other words, m memory cell blocks 15). In addition, in the neural network integrated circuit C1′, one majority determination input circuit 12 is shared by (m) memory cell pairs in a horizontal row in the memory cell array MC1 illustrated in FIG. 22B. In addition, the timing signals φ₁ and the like are commonly input to the memory cell array MC1, each majority determination input circuit 12, and each serial majority determination circuit 13. However, for simplification of description, these are not illustrated in FIG. 22B.

In the configuration described above, from the memory cells 10 of the memory cell blocks 15 forming each neural network circuit CS′, the weighting coefficient W is output simultaneously for the memory cells 10 included in one memory cell block 15 and sequentially (that is, in a serial form) for the m memory cell blocks 15. Then, the above-described exclusive OR between the weighting coefficient W and the m pieces of input data I (each piece of input data I has one bit) input in a serial form at the corresponding timing is calculated in a time-divisional manner by the shared majority determination input circuit 12, and is output as the output data E to the corresponding serial majority determination circuit 13 in a serial form. On the other hand, from the memory cells 11 of the memory cell blocks 15 forming each neural network circuit CS′, the above-described connection presence/absence information C is output simultaneously to the memory cells 11 included in one memory cell block 15 and sequentially (that is, in a serial form) to the m memory cell blocks 15. Then, the connection presence/absence information C is output to the corresponding serial majority determination circuit 13 through the shared majority determination input circuit 12 in a serial form corresponding to the input timing of the input data I. In addition, the output timing mode of each weighting coefficient W from each memory cell block 15 and the output timing mode of the connection presence/absence information C from each memory cell block 15 are the same for each memory cell 11 in the neural network integrated circuit described below with reference to FIGS. 23 to 27.

Then, each of the n serial majority determination circuits 13 to which the output data E and the connection presence/absence information C are input from each majority determination input circuit 12 adds the number of pieces of output data E having a value “1” to calculate the total value and adds the number of pieces of output data E having a value “0” to calculate the total value for the maximum m pieces of output data E for which the connection presence/absence information C input at the same timing indicates “there is a connection”. These additions correspond to the above-described addition processing. Then, each of the serial majority determination circuits 13 compares the total value of the number of pieces of output data E having a value “1” with the total value of the number of pieces of output data E having a value “0”, and the output data O having a value “1” is output only when a value obtained by subtracting the latter number from the former number is equal to or greater than a majority determination threshold value set in advance in the same manner as in the above-described majority determination threshold value according to the embodiment. On the other hand, in other cases, that is, when the value obtained by subtracting the total value of the number of pieces of output data E having a value “0” from the total value of the number of pieces of output data E having a value “1” is less than the majority determination threshold value, each serial majority determination circuits 13 outputs the output data O having a value “0”. The processing in each of the serial majority determination circuits 13 corresponds to the activation processing, and each output data O is one bit. Here, when the connection presence/absence information C output at the same timing indicates “no connection”, the serial majority determination circuit 13 does not add the output data E to the number of pieces of output data E having a value “1” and the number of pieces of output data E having a value “0”. Then, each serial majority determination circuit 13 repeats outputting the one-bit output data O by each of the above-described processes in accordance with the timing at which the input data I is input. As a result, the pieces of output data O at this time are output in parallel from the serial majority determination circuits 13. In this case, the total number of pieces of output data O is n. As described above, each of the multiplication processing, the addition processing, and the activation processing corresponding to one neuron NR indicated by hatching in FIG. 22A is performed by the memory cell pairs corresponding to one row in the memory cell array MC1 illustrated in FIG. 22B and the majority determination input circuit 12 and the serial majority determination circuit 13 corresponding thereto.

As described above, the neural network S1′, in which the one-bit output data O is output from each of the m neurons NR to the n neurons NR indicated by hatching in FIG. 22A so that a total of n pieces of output data O are output from the n neurons NR, is modeled by the neural network integrated circuit C1′ having the configuration illustrated in FIG. 22B.

(C) First Example of Neural Network Circuit According to Related Form

Next, a first example of the neural network circuit according to the related form will be described with reference to FIG. 23.

As illustrated in FIG. 23A, the neural network S corresponding to the first example has basically the same configuration as the neural network S according to the embodiment illustrated in FIG. 15A. However, in the example illustrated in FIG. 23A, one-bit input data I (when viewed from the other neurons NR, output data O) is input in parallel from three other neurons NR to one neuron NR indicated by hatching in FIG. 23A, and one piece of output data O corresponding thereto is output in a serial form from the neuron NR. The output data O at this time is also a one-bit signal similarly to the input data I. Therefore, both the value of the input data I and the value of the output data O illustrated in FIG. 23 are “0” or “1”. Then, the above Equation (1) corresponding to the above multiplication processing and the like performed in the neuron NR illustrated in FIG. 23A is an equation when n=3 in the above Equation (1). That is, the neural network S is a parallel input-serial output type one-stage neural network.

Next, the configuration of the first example of the neural network circuit according to the related form corresponding to the neuron NR indicated by hatching in FIG. 23A is illustrated as a neural network circuit CCS' in FIG. 23B. The neural network circuit CCS' according to the related form corresponding to the neuron NR is configured to include three sets of memory cells 10 and memory cells 11 each corresponding to the input data I illustrated in FIG. 23A and a parallel majority determination circuit 20 to which the respective pieces of input data I are input. At this time, the number of memory cell pairs of one memory cell 10 and one memory cell 11 and the number of majority determination input circuits 12 corresponding thereto (both three in the case illustrated in FIG. 23) are equal to the number of pieces of input data I desired as the neural network S illustrated in FIG. 23A. In addition, in the following description of FIG. 23, the above-described memory cell pairs corresponding to the number of pieces of input data I are illustrated as memory cell blocks 15 (refer to a broken line in FIG. 23B).

In the configuration described above, each memory cell 10 in each memory cell block 15 stores the one-bit weighting coefficient W set in advance based on the brain function that the neural network circuit CCS' should support. On the other hand, each memory cell 11 in each memory cell block 15 stores one-bit connection presence/absence information set in advance based on the brain function. Here, since the connection presence/absence information is the same as the connection presence/absence information Cₙ in the first example of the neural network circuit according to the related form described with reference to FIGS. 21 and 22, detailed description thereof will be omitted. In addition, which storage value is to be stored in each of the memory cells 10 and 11 may be set in advance based on, for example, which brain function is to be modeled as the neural network S illustrated in FIG. 23A.

Then, the respective memory cells 10 output the storage values to the parallel majority determination circuit 20 as a weighting coefficient W₁, a weighting coefficient W₂, and a weighting coefficient W₃ at the same timing as in each memory cell 10 illustrated in FIG. 21B. On the other hand, the respective memory cells 11 also output the connection presence/absence information C, which is the storage value, to the parallel majority determination circuit 20 at the same timing as in each memory cell 11 illustrated in FIG. 21B.

On the other hand, as described above, the input data I₁, input data I₂, and input data I₃ (each having one bit) are input in parallel to the parallel majority determination circuit 20. Then, the parallel majority determination circuit 20 performs operations (that is, the above-described multiplication processing, addition processing, and activation processing) including the same operation as in one set of majority determination input circuit 12 and serial majority determination circuit 13 described with reference to FIG. 22. Specifically, first, when the corresponding connection presence/absence information C indicates “there is a connection”, the parallel majority determination circuit 20 determines the above-described exclusive OR between each one-bit piece of one-bit input data I and the corresponding weighting coefficient W for each piece of input data I. Then, the parallel majority determination circuit 20 adds the number of operation results of a value “1” to each of the operation results to calculate the total value, and adds the number of operation results of a value “0” to each of the operation results to calculate the total value. Then, the parallel majority determination circuit 20 compares the total value of the number of operation results of a value “1” with the total value of the number of operation results of a value “0”, and the output data O having a value “1” is output in a serial form only when a value obtained by subtracting the latter number from the former number is equal to or greater than a majority determination threshold value set in advance in the same manner as in the above-described majority determination threshold value according to the embodiment. On the other hand, in other cases, that is, when the value obtained by subtracting the total value of the number of pieces of output data E having a value “0” from the total value of the number of pieces of output data E having a value “1” is less than the majority determination threshold value, the parallel majority determination circuit 20 outputs the output data O having a value “0” in a serial form. In this case, the output data O is one bit. Here, when the corresponding connection presence/absence information C indicates “no connection”, the parallel majority determination circuit 20 does not calculate the exclusive OR. In addition, the above-described exclusive OR between each piece of input data I and the corresponding weighting coefficient W may be once calculated for all the pieces of input data I, and the operation result may not be added to both the number of operation results of a value “1” and the number of operation results of a value “0” when the corresponding connection presence/absence information C indicates “no connection”. Then, the parallel majority determination circuit 20 repeats outputting the one-bit output data O in a serial form by each of the above-described processes, by the number of pieces of input data I that are input in parallel. By the above-described processes, the neural network circuit CCS' illustrated in FIG. 23B becomes a circuit that models the above multiplication processing, addition processing, and activation processing in the neuron NR indicated by hatching in FIG. 23A.

(D) Second Example of Neural Network Integrated Circuit According to Related Form

Next, a second example of the neural network integrated circuit according to the related form will be described with reference to FIGS. 24A and 24B. In addition, in FIG. 24, the same components as those of the neural network circuit according to the related form described with reference to FIG. 23 are denoted by the same reference numerals, and detailed description thereof will be omitted.

The second example of the neural network integrated circuit according to the related form described with reference to FIG. 24 is an integrated circuit in which a plurality of neural network circuits CCS' according to the related form described with reference to FIG. 23 are integrated, and is for modeling a complicated neural network including a larger number of neurons NR.

First, a neural network modeled by the second example of the neural network integrated circuit according to the related form will be described with reference to FIG. 24A. The neural network ST illustrated in FIG. 24A is configured such that one-bit output data O (when viewed from m neurons NR, input data I) is input in parallel from n neurons NR to each of m neurons NR indicated by hatching in FIG. 24A and the output data O corresponding thereto is output in a serial form from the neuron NR. The output data O at this time is also a one-bit signal similarly to the input data I. Therefore, both the value of the input data I and the value of the output data O illustrated in FIG. 24 are “0” or “1”. That is, the neural network S2′ is a parallel input-serial output type one-stage neural network.

The second example of the neural network integrated circuit according to the related form in which the neural network S2′ is modeled is a neural network integrated circuit C2′ illustrated in FIG. 24B. The neural network integrated circuit C2′ includes m neural network circuits CCS' (refer to FIG. 23) according to the related form, each of which includes the above-described n memory cell pairs, and includes the parallel majority determination circuit 20. Then, as illustrated in FIG. 24B, the memory cell array MC2 is configured to include the n×m memory cell pairs (in other words, m memory cell blocks 15). In addition, in the neural network integrated circuit CT, one parallel majority determination circuit 20 is shared by (m) memory cell pairs in a horizontal row in the memory cell array MC2 illustrated in FIG. 24B. In addition, the timing signals φ₁ and the like are commonly input to the memory cell array MC2 and the parallel majority determination circuit 20. However, for simplification of description, these are not illustrated in FIG. 24B.

In the configuration described above, from the memory cells 10 of the memory cell blocks 15 forming each neural network circuit CCS′, the weighting coefficient W is output to the parallel majority determination circuit 20 at the same timing as in each memory cell 10 and each memory cell block 15 illustrated in FIG. 22B. On the other hand, from the memory cells 11 of the memory cell blocks 15 forming each neural network circuit CCS′, the above-described connection presence/absence information C is output to the parallel majority determination circuit 20 at the same timing as in each memory cell 11 and each memory cell block 15 illustrated in FIG. 22B.

Then, based on the weighting coefficient W and the connection presence/absence information C output from the memory cell array MC2 and the input data I corresponding thereto, the parallel majority determination circuit 20 performs, for one horizontal row (m pieces) in the memory cell array MC2, operation processing of the exclusive OR using the input data I and the weighting coefficient W in which the connection presence/absence information C indicates “there is a connection”, addition processing of the number of operation results of a value “1” and the number of operation results of a value “0” based on the operation result, comparison processing of the total numbers based on the addition result (refer to FIG. 23B), and generation processing of the output data O based on the comparison result. In addition, the parallel majority determination circuit 20 performs the operation processing, the addition processing, the comparison processing, and the generation processing for the one horizontal row, on each piece of input data I, in a serial form for each memory cell block 15, and outputs the output data O in a serial form as each execution result. Here, when the corresponding connection presence/absence information C indicates “no connection”, the parallel majority determination circuit 20 does not perform the above-described operation processing, addition processing, comparison processing, and generation processing.

As described above, the neural network S2′, in which the output data O is output from each of the n neurons NR to the m neurons NR indicated by hatching in FIG. 24A so that one-bit output data O is output in a serial form from the m neurons NR, is modeled by the neural network integrated circuit C2′ having the configuration illustrated in FIG. 24B.

(E) Third Example of Neural Network Integrated Circuit According to Related Form

Next, a third example of the neural network integrated circuit according to the related form will be described with reference to FIG. 25. In addition, in FIG. 25, the same components as those of the neural network circuit according to the related form described with reference to FIGS. 21 and 23 are denoted by the same reference numerals, and detailed description thereof will be omitted.

The third example of the neural network integrated circuit according to the related form described with reference to FIG. 25 is an integrated circuit in which the neural network integrated circuit C1′ according to the related form described with reference to FIG. 22 and the neural network integrated circuit C2′ according to the related form described with reference to FIG. 24 are combined. Here, the neural network integrated circuit C1′ is a neural network circuit obtained by modeling the serial input-parallel output type one-stage neural network S1′ as described above. On the other hand, the neural network integrated circuit C2′ is a neural network circuit obtained by modeling the parallel input-serial output type one-stage neural network S2′ as described above. In addition, the third example of the neural network integrated circuit according to the related form in which these are combined is a neural network integrated circuit obtained by modeling a serial input-parallel processing-serial output type multi-stage neural network as a whole, and is for modeling a complicated neural network including an even larger number of neurons NR.

First, a neural network modeled by the third example of the neural network integrated circuit according to the related form will be described with reference to FIG. 25A. A neural network S1-2 illustrated in FIG. 25A is a neural network in which one-bit output data O is output in a serial form from each of the m neurons NR to each of the n neurons NR indicated by 45° hatching in FIG. 25A, transmission and reception of the output data O and the input data I are performed between the neurons NR indicated by the 45° hatching and the m neurons NR indicated by 135° hatching in FIG. 24A, and consequently the output data O is output in a serial form from each of the m neurons NR indicated by 135° hatching. In addition, as a whole, the neural network S1-2 corresponds to a neural network in which a plurality of neural networks S1 described with reference to FIG. 17 are arranged.

The third example of the neural network integrated circuit according to the related form in which the neural network S1-2 is modeled is a neural network integrated circuit C1-2 illustrated in FIG. 25B. The neural network integrated circuit C1-2 has a configuration in which each piece of output data O (each of pieces of output data O that are output in parallel) of the neural network integrated circuit C1′ described with reference to FIG. 22 is input data (that is, the input data I illustrated in FIG. 24B) to the parallel majority determination circuit 20 in the neural network integrated circuit C2′ described with reference to FIG. 24 and accordingly, the output data O is output in a serial form from the parallel majority determination circuit 20. As described above, by combining the neural network integrated circuit C1′ and the neural network integrated circuit C2′, the neural network S1-2 is consequently modeled in which the neural network S1′ illustrated in FIG. 22A and the neural network S2′ illustrated in FIG. 24A are combined. In addition, the operations of the neural network integrated circuit C1′ and the neural network integrated circuit C2′ included in the neural network S1-2 are the same as the operations described with reference to FIGS. 22 and 24. In addition, in the neural network integrated circuit C1-2 illustrated in FIG. 25B, the serial majority determination circuit 16 corresponding to the parallel majority determination circuit 20 is configured to include a set of the majority determination input circuit 12 and the serial majority determination circuit 13 shown by the broken lines.

As described above, the neural network S1-2 illustrated in FIG. 25A is modeled by the neural network integrated circuit C1-2 having a serial input-parallel processing-serial output type configuration illustrated in FIG. 25B.

(F) Fourth Example of Neural Network Integrated Circuit According to Related Form

Next, a fourth example of the neural network integrated circuit according to the related form will be described with reference to FIGS. 26 and 27. In addition, in FIGS. 26 and 27, the same components as those of the neural network circuit according to the related form described with reference to FIGS. 22, 24, and 25 are denoted by the same reference numerals, and detailed description thereof will be omitted.

As illustrated in FIG. 26A, the fourth example of the neural network integrated circuit according to the related form described with reference to FIG. 26 is a neural network integrated circuit C1-3 having a configuration in which a pipeline register 21 is interposed between the neural network integrated circuit C1′ and the neural network integrated circuit C2′ that form the neural network integrated circuit C1-2 according to the related form described with reference to FIG. 25. At this time, the pipeline register 21 temporarily stores a number of pieces of data corresponding to the bit width of the memory cell array MC1, and its output operation is controlled by an enable signal EN from the outside. The enable signal EN is a timing signal corresponding to an even-numbered reference clock among reference clock signals set in advance. In addition, as illustrated in FIG. 26B, as a whole, the neural network integrated circuit C1-3 has a configuration in which a parallel operator PP, to which, for example, m pieces of one-bit input data I are input in a serial form and the enable signal EN is input and from which, for example, m pieces of one-bit output data O corresponding thereto are output in a serial form, is interposed between the memory cell array MC1 in the neural network integrated circuit C1′ and the memory cell array MC2 in the neural network integrated circuit C2′. At this time, each of the memory cell array MC1 and the memory cell array MC2 has, for example, a width of 256 bits and a scale of 512 words (Word), and, for example, eight-bit address data AD for address designation is input thereto. Then, the parallel operator PP in this case is configured to include the majority determination input circuit 12 and the serial majority determination circuit 13 corresponding to 256 bits, the pipeline register 21, and the parallel majority determination circuit 20 corresponding to 256 bits.

In the configuration described above, the operations of the neural network integrated circuit C1′ and the neural network integrated circuit C2′ included in the neural network S1-3 are the same as the operations described with reference to FIGS. 22 and 24. On the other hand, the pipeline register 21 temporarily stores the output data O read from the memory cell array MC1 of the neural network integrated circuit C1′ at a timing at which the parallel majority determination circuit 20 performs processing for generating/outputting the output data O based on the weighting coefficient W and the connection presence/absence information C read from the memory cell array MC2 of the neural network integrated circuit C2′, for example. Then, at a timing at which the processing of the parallel majority determination circuit 20 based on the weighting coefficient W and the connection presence/absence information C is completed, the output data O read from the memory cell array MC1 and stored is output to the parallel majority determination circuit 20 so that the processing for generating/outputting the output data O based thereon is performed. By this processing, apparently, reading of the output data O from the memory cell array MC1 and reading of the weighting coefficient W and the connection presence/absence information C from the memory cell array MC2 can be performed at the same time. As a result, it is possible to realize approximately twice the processing speed of the neural network S1-2 described with reference to FIG. 25.

Next, the detailed configuration of especially the parallel operator PP in the neural network circuit C1-3 illustrated in FIG. 26 will be described with reference to FIG. 27.

First, as illustrated in FIG. 27A, the parallel operator PP is configured to include serial majority determination circuits 16 each including the majority determination input circuits 12 and the serial majority determination circuits 13 corresponding to the bit width of the memory cell array MC1, the pipeline register 21 corresponding to the bit width of the memory cell array MC1, and the parallel majority determination circuit 20 that outputs the output data O through an output flip-flop circuit 22. In this configuration, as illustrated in FIG. 27A, the pipeline register 21 is configured to include an output register 21U and an input register 21L corresponding to the bit width of the memory cell array MC1, and the enable signal EN is input to the input register 21L. Then, the input register 21L outputs data stored (latched) therein to the parallel majority determination circuit 20 at a timing at which the enable signal EN is input, and fetches (that is, shifts) data stored in the output register 21U at the timing and stores (latches) the data. In addition, as a result, the output register 21U stores (latches) the next output data O at a timing at which the data is fetched by the input register 21L. By repeating the above operations of the input register 21L and the output register 21U, the operation as the pipeline register 21 described above is realized.

Next, the detailed configurations of the majority determination input circuit 12 and the serial majority determination circuit 13 will be described with reference to FIG. 27B. As illustrated in FIG. 27B, the majority determination input circuit 12 in one serial majority determination circuit 16 is configured to include an exclusive OR circuit 12A and a mask flip-flop circuit 12B. In this configuration, the weighting coefficient W from the memory cell array MC1 and the one-bit input data I are input to the exclusive OR circuit 12A, and the result of the exclusive OR is output to the serial majority determination circuit 13 as the output data E. In addition, the mask flip-flop circuit 12B receives the connection presence/absence information C from the memory cell array MC1 and the enable signal EN, and outputs the connection presence/absence information C to the serial majority determination circuit 13 at a timing at which the enable signal EN is input. Then, the serial majority determination circuit 13 generates the output data O by the above-described operation based on the output data E and the connection presence/absence information C, and outputs the output data O to the output register 21U of the pipeline register 21. At this time, by holding the predetermined majority determination threshold value in a register (not illustrated) in the serial majority determination circuit 13 and referring to the predetermined majority determination threshold value, the operation as the serial majority determination circuit 13 can be realized.

Next, the detailed configuration of the parallel majority determination circuit 20 will be described with reference to FIG. 27C. As illustrated in FIG. 27C, the parallel majority determination circuit 20 is configured to include an exclusive OR circuit 20A, a mask flip-flop circuit 20B, and a parallel majority decision circuit 20C. In this configuration, the one-bit weighting coefficient W from the memory cell array MC2 and the one-bit output data O from the input register 21L of the pipeline register 21 are input to the exclusive OR circuit 20A, and the result of the exclusive OR is output to the parallel majority decision circuit 20C. In addition, the mask flip-flop circuit 20B receives the connection presence/absence information C from the memory cell array MC2 and the enable signal EN, and outputs the connection presence/absence information C to the parallel majority decision circuit 20C at a timing at which the enable signal EN is input. Then, the parallel majority decision circuit 20C repeats the above-described operation based on the outputs from the exclusive OR circuit 12A and the mask flip-flop circuit 20B corresponding to one set of weighting coefficient W and connection presence/absence information C from the memory cell array MC2 by the number of pieces of output data O from the memory cell array MC1 (256 in the case illustrated in FIGS. 26 and 27), and outputs the result as the output data O in a serial form through the output flip-flop circuit 22. At this time, by holding the predetermined majority determination threshold value in a register (not illustrated) in the parallel majority determination circuit 20 and referring to the predetermined majority determination threshold value, the operation as the parallel majority determination circuit 20 can be realized.

At this time, by the operation of the pipeline register 21 described above, in the parallel operator PP, for example, as illustrated in FIG. 27D, processing (illustrated as “memory cell block 15U1” in FIG. 27D) on the output data O corresponding to 256 bits from the memory cell array MC1 ends, and then processing (illustrated as “memory cell block 15U2” in FIG. 27D) on the output data O corresponding to the next 256 bits from the memory cell array MC1 and processing (illustrated as “memory cell block 15_{L1}” in FIG. 27D) on the weighting coefficient W and the connection presence/absence information C corresponding to 256 bits from the memory cell array MC2 are performed apparently simultaneously and in parallel. Then, when the processing on the output data O corresponding to the memory cell block 15_{U2} and the weighting coefficient W and the connection presence/absence information C corresponding to the memory cell block 15_{L1} ends, the next processing (illustrated as “memory cell block 15U3” in FIG. 27D) on the output data O corresponding to the further next 256 bits from the memory cell array MC1 and processing (illustrated as “memory cell block 15_{L2}” in FIG. 27D) on the weighting coefficient W and the connection presence/absence information C corresponding to the next 256 bits from the memory cell array MC2 are performed apparently simultaneously and in parallel. Thereafter, sequential and simultaneous and in-parallel processing is performed on the output data O, the weighting coefficient W, and the connection presence/absence information C corresponding to 256 bits from each of the memory cell array MC1 and the memory cell array MC2.

In addition, the detailed configurations of the majority determination input circuit 12 and the serial majority determination circuit 13 illustrated in FIG. 27B and the detailed configuration of the parallel majority determination circuit 20 illustrated in FIG. 27C are configurations based on the assumption that the output timing of the connection presence/absence information C from each memory cell 11 illustrated in FIG. 21 and subsequent diagrams is earlier than the output timing of the weighting coefficient W from each memory cell 10 illustrated in FIG. 21 and subsequent diagrams, for example, by one cycle. Absorbing the deviation in the output timing is the functions of the mask flip-flop circuit 12B and the mask flip-flop circuit 20B illustrated in FIGS. 27(b) and 27(c). On the other hand, the output timing of the weighting coefficient W and the output timing of the connection presence/absence information C can be set simultaneously and in parallel. In addition, in this case, the mask flip-flop circuit 12B and the mask flip-flop circuit 20B illustrated in FIGS. 27(b) and 27(c) are not necessary as the majority determination input circuit 12 and the parallel majority determination circuit 20.

As described above, according to the neural network circuit C1-3 illustrated in FIGS. 26 and 27, the neural network S1-2 illustrated in FIG. 25A can be modeled with an approximately double processing speed. In addition, the detailed configuration of the serial majority determination circuit 16 described with reference to FIG. 27 can be applied as the detailed configuration of the serial majority determination circuit 16 included in the neural network integrated circuit C1-2 described with reference to FIG. 25.

### INDUSTRIAL APPLICABILITY

As described above, the present invention can be used in the field of a neural network circuit and the like in which a neural network is modeled. In particular, when the present invention is applied to the case of reducing the manufacturing cost or developing efficient neural network circuits and the like, a particularly noticeable effect can be obtained.

### REFERENCE SIGNS LIST

NN: NEURAL ELECTRONIC CIRCUIT
NNS: NEURAL NETWORK SYSTEM
MC: MEMORY CELL ARRAY UNIT (STORAGE UNIT)
Pe: PROCESS ELEMENT UNIT (FIRST ELECTRONIC CIRCUIT UNIT)
PC1 • • • PCn: PROCESS ELEMENT COLUMN
Act: ADDITION ACTIVATION UNIT (SECOND ELECTRONIC CIRCUIT UNIT)

1. A neural electronic circuit, comprising: a storage unit that stores a logarithmic weighting coefficient, in which a value obtained by logarithmizing a weighting coefficient corresponding to input data that is input is expressed in multiple bits, and outputs the logarithmic weighting coefficient bit by bit;
a first electronic circuit unit that outputs a multiplication result of the input data and the weighting coefficient; and
a second electronic circuit unit that realizes addition and application functions for adding up the multiplication results from the first electronic circuit units, applying an activation function to the addition result, and outputting output data,
wherein the first electronic circuit unit receives logarithmic input data, in which a value obtained by logarithmizing the input data is expressed in multiple bits, bit by bit, calculates a logarithmic addition by adding up the logarithmic input data and the logarithmic weighting coefficient output from the storage unit, and calculates the multiplication result by linearizing the logarithmic addition result, and
the second electronic circuit unit outputs the output data that is logarithmized.

2. The neural electronic circuit according to claim 1,
wherein the second electronic circuit unit outputs the logarithmic output data by applying the activation function to the logarithmic addition result obtained by logarithmizing the addition result.

3. The neural electronic circuit according to claim 2,
wherein the first electronic circuit unit calculates an approximate multiplication result by the linearization of the logarithmic addition result using an approximate expression, and
the second electronic circuit unit outputs the output data that is logarithmized by adding up the approximate multiplication results by an approximate expression.

4. The neural electronic circuit according to claim 1,
wherein the storage unit stores the logarithmic weighting coefficient according to each of the pieces of parallel logarithmic input data that are input in parallel,
the first electronic circuit unit is set in each of the pieces of parallel logarithmic input data, and
the second electronic circuit unit adds up the multiplication results of the pieces of parallel logarithmic input data from the first electronic circuit unit.

5. The neural electronic circuit according to claim 4, wherein the storage unit and the second electronic circuit unit are set according to the pieces of output data that are output in parallel.

6. The neural electronic circuit according to claim 4, further comprising:
a temporary storage unit that is provided for each of the first electronic circuit units to temporarily store the multiplication result from each of the first electronic circuit units,
wherein the temporary storage units are set in series, and sequentially transfer the multiplication results to the second electronic circuit unit.

7. The neural electronic circuit according to claim 4,
wherein the storage unit sequentially outputs logarithmic weighting coefficients corresponding to the logarithmic input data, which is sequentially input to the first electronic circuit unit, to the first electronic circuit unit bit by bit.

8. The neural electronic circuit according to claim 7,
wherein the first electronic circuit unit outputs a partial addition result obtained by adding up the multiplication results by the input parallel number of pieces of logarithmic input data that are input in parallel, and
the second electronic circuit unit calculates the addition result from the partial addition result.

9. The neural electronic circuit according to claim 4,
wherein the storage unit outputs a logarithmic weighting coefficient corresponding to each of the pieces of parallel logarithmic input data, which are input in parallel, to the first electronic circuit units bit by bit.

10. The neural electronic circuit according to claim 9, wherein, when the input parallel number of pieces of logarithmic input data is larger than an inputtable parallel number by which the pieces of logarithmic input data are inputtable at a time in parallel, the first electronic circuit unit receives the logarithmic input data in parallel by the inputtable parallel number and then receives the remaining logarithmic input data that could not be received in parallel by the inputtable parallel number, and the storage unit outputs the logarithmic weighting coefficient corresponding to the remaining logarithmic input data.
